(19) United States
(12) Patent Application Publication
(10) Pub. No.: US 2011/0192548 A1
(43) Pub. Date: Aug. 11, 2011

(54) METHOD OF MANUFACTURE OF AN ENERGY ABSORBING TIRE CAGE

(75) Inventors: Dennis J. Dupray, Golden, CO (US); Donald Kent Wilson, Thunder Bay (CA)

(73) Assignee: Goldcorp Inc., Vancouver (CA)

(21) Appl. No.: 13/088,244

(22) Filed: Apr. 15, 2011

Related U.S. Application Data
(63) Continuation-in-part of application No. 11/627,813, filed on Jan. 26, 2007, now abandoned.
Application No. 11/627,813 is a division of application No. 10/971,819, filed on Oct. 21, 2004, now Pat. No. 7,240,713.
(60) Provisional application No. 61/380,648, filed on Sep. 7, 2010.
(60) Provisional application No. 61/467,931, filed on Mar. 25, 2011.

(51) Int. Cl. B60B 30/00

(52) U.S. Cl. 157/14

(57) ABSTRACT

A tire cage is disclosed for containing the debris from a tire explosion. The cage includes a lightweight energy absorbing material for protecting structural members of the cage from tire explosion damage so that the cage is reusable. The energy absorbing material may be a metallic foam or other open celled structured material that is able to absorb large amounts of kinetic energy by permanently deforming. The cage is particularly effective in containing explosions of large equipment tires 6 to 12 feet in diameter and having a stored kinetic energy in a range of approximately 900 kilojoules to 1500 kilojoules.

### RELATED APPLICATION

The present application claims the benefit of U.S. Provisional Patent Application Ser. No, 61/380,648 Entitled “SAFETY TIRE CAGE”, filed Sep. 7, 2010, and claims the benefit of U.S. Provisional Patent Application Ser. No. 61/467,931 Entitled “METHOD OF MANUFACTURE OF AN ENERGY ABSORBING TIRE CAGE”, filed Mar. 25, 2011; the present application is also a continuation-in-part of U.S. patent application Ser. No. 11/627,813, filed Jan. 26, 2007, entitled “METHOD AND APPARATUS FOR CONTROLLING DEBRIS FROM AN EXPLODING TIRE” which is a divisional of U.S. patent application Ser. No. 10/971,819, filed Oct. 21, 2004, now U.S. Pat. No. 7,240,713 entitled “ENERGY ABSORBING TIRE CAGE AND METHOD OF USE”; each of the above-identified applications are fully incorporated by reference herein.

### RELATED FIELD OF THE INVENTION

The present invention relates to a cage tire for containing tire explosions, and in particular, to tire cages for containing tire explosions of having a diameter in the range of 6 to 12 feet, and having stored energy, e.g., in a range of 500 kilojoules to 7500 kilojoules which is approximately 13-200 times the energy of a conventional truck/SUV tire.

### BACKGROUND

It is well known that inflation or deflation of certain tires can be hazardous to personnel performing such operations and to others nearby. In particular, split rim tires are known to be especially dangerous in that metal portions of the split rim can be propelled at high velocity if the tire fails. Moreover, such tire failures where portions of the split rim may become projectiles is especially dangerous when inflating or deflating such tires. This is true of virtually all split rim tires, and there have been various devices developed to hold or secure split rim tires for light vehicles (e.g., cars or trunks). However, for inflation or deflation of very large tires such as those on heavy/industrial mobile equipment (e.g., loaders, graders, large earth moving equipment), there heretofore has not been any equipment developed or proposed for containing the extreme explosiveness and potential destructiveness of such very large tires that are, e.g., 8 to 10 feet (or more) in diameter. Said another way, size does indeed matter when it comes to the dangerousness and destructiveness of a large tire explosion. In particular, all known prior art apparatuses for containing such large tire explosions are immobile and exceedingly large.

Accordingly, it would be desirable to have a mobile tire cage that is relatively lightweight and is able to effectively contain the explosion of a large tire. Moreover, it would be desirable that such cage be reusable.

### SUMMARY

The present disclosure shows a tire cage for:
(A) Safely inspecting a split rim tire, e.g., prior to, during and after inflation or deflation of the tire for anomalous conditions such as a misalignment between portions of the split rim and/or misalignment between the split rim and the tire thereon;
(B) Containing a tire explosion;
(C) Easily re-provisioning the tire cage after a tire explosion therein so that the cage can be reused.

Regarding (A) immediately above, the disclosed tire cage includes imaging devices for inspecting a tire in the tire cage, and in particular, such imaging devices are positioned so that the visible portions of the tire's split rim as well at least the tire casing adjacent thereto can be imaged for inspecting remotely from the tire. To perform such imaging, the imaging devices and the tire may be rotated relative to one another so that each side of the tire can be imaged, and in particular, the split rim together with its juncture with the tire casing, for identifying such anomalous or potentially unsafe conditions such as:
(i) a split rim ring that is not properly seated for locking the tire rim and the tire casing together;
(ii) a cracked, broken or mis-shaped portion of the split rim component (e.g., such a component may be a ring of the split rim, a bolt, a rim or hub section of a multi-piece split rim);
(iii) a cut or gash in the tire casing that is severe enough to potentially cause the tire to fail upon inflation;
(iv) an indication that the tire has been in operation while underinflated thereby weakening the internal structure of the tire;
(v) an indication that the tire has been in operation while overinflated thereby weakening the internal structure of the tire;
(vi) a damaged component of a multi-piece rim assembly; and
(vii) a mismatch of components of a multi-piece rim (e.g., multi-piece rim components not designed to operate, mate, or function together in a single multi-piece rim).
   In particular, the tire cage of the present disclosure is designed to contain all portions of a split rim that could otherwise cause harm and/or damage if propelled unimpeded from a tire explosion. More particularly, embodiments of the tire cage of the present invention are suited for containing debris from large tires such as those used on earth moving vehicles, such tires being, e.g., 6 to 12 feet in diameter. Additionally, embodiments of the tire cage are reusable in that the structural members of the tire cage are protected from a sufficient amount of the effects of tire explosion sudden impact such that such structural members are not damaged. Such protection is accomplished by converting tire explosion impact energy into plastic deformation energy, thereby keeping the peak force exerted on the structural members of the cage below the level that causes damage. That is, the tire cage includes replaceable, kinetic energy absorbing materials that can absorb, without damaging the structural members of the cage (e.g., frame beams and steel plates), a tire explosion impact force of, depending on the cage embodiment, a tire 6 to 12 feet in diameter. In particular, an embodiment of the tire cage for an tire 8 feet in diameter is intended to absorb a tire explosion of 3500 to 3700 kiloNewtons, and absorb approximately 900 kilojoules to 1500 kilojoules, and more preferably 1160 kilojoules (855,853 ft-lbs) of kinetic energy from, e.g., a flange and bead seat band of a split rim tire propelled toward such structural members of the tire cage.

It is an important aspect of the tire cage of the present disclosure that embodiments for receiving large tires are relatively lightweight and easily transported to where such large tires are in use. This is especially important in view of the fact that energy stored within tires increases exponentially with the size of the tire (e.g., a typical truck tire of 3 foot diameter may store approximately 60 kilojoules of energy, a typical inflated 6 foot diameter tire may store approximately 500 kilojoules of energy, a typical inflated 8 foot diameter tire may store approximately 1200 kilojoules, and a typical inflated 12 foot diameter tire may store approximately 7500 kilojoules). Thus, even for 8 to 12 foot diameter tires, embodiments of the present invention may be:
(a) Less than approximately ten tons (and more preferably between seven and ten tons or less), and
(b) Not substantially larger than the tires provided therein (e.g., occupying a volume of less than approximately five times the size of a tire received therein). That is, the outside dimensions of such a tire cage may be such that the volume for the entire cage is no larger than approximately three to ten times the volume of the maximum size tire that the tire cage can accept and safely contain an explosion thereof, and preferably the entire cage is no larger than approximately three to seven times the volume of the maximum size tire that the tire cage can accept and safely contain an explosion thereof.

To provide the above transportability features and to additionally provide a more cost effective tire cage for large tires than heretofore possible, it is an aspect of the present invention to use a light weight energy absorbing material such as an energy absorbing metallic foam to cushion the frame of the present tire cage from being damaged by high velocity portions of an exploding tire, and particular, portions of a split rim. The use of such energy absorbing foams substantially reduces the weight and size of the tire cage. Additionally, the tire cage is designed so that the energy absorbing foam can be replaced after it has been crushed while absorbing the impact of portions of an exploding tire. Thus, it is an aspect of the present invention that the tire cage is reusable by substantially merely replacing the crushed foam (and related components for securing the foam in position) after a tire explosion occurs within the tire cage.

In at least some embodiments of tire cage, the energy absorbing foam includes an aluminum foam. Moreover, such foams may have a relative density in a range of 7-12% as one skilled in the art will understand.

Various enhancements to the above tire cage embodiments, and/or additional embodiments are also considered within the scope of the present disclosure. In particular, an embodiment of the tire cage may include various devices for assisting an operator in inspecting a tire within the cage. Such devices may include tire imaging equipment such as one or more cameras, and/or video recording devices, wherein such devices may provide images of various portions of a tire within the tire cage so that, e.g., prior to inflation or deflation, a tire cage operator can inspect the tire more effectively, efficiently and safely than by, e.g., walking around and possibly climbing on the tire cage in order to inspect the tire. In particular, such imaging devices may communicate their images to one or more video monitors at, e.g., an operator station (safely remote from the tire cage) so that the operator can, from this station, raise, lower and/or rotate the tire positioned on a tire supporting pedestal within the cage for viewing and inspecting the tire via corresponding images presented on these monitors. An embodiment of the tire cage can be provided with a corresponding operator station having one or more computer display monitors, wherein the monitor(s) may allow the operator to view various portions of the tire simultaneously if desired. The operator station may additionally include various controls for securing the tire within the tire cage (e.g., locking a lid of the tire cage), positioning the tire within the cage (e.g., rising, lowering, or rotating the tire), and/or inflating or deflating the tire. In one embodiment, safety features such as checks to assure that important portions of the tire have been imaged by the imaging equipment may be provided. For example, inflation and/or deflation may be prevented until the tire has been rotated at least one full 360 degree rotation on the pedestal with the imaging equipment active for obtaining images of, e.g., the entire visible portion of the tire's split rim, the tire itself, and/or the contact between the two. Moreover, such tire and split rim images may be archived for, e.g., operator training, recording the condition of a tire before it has exploded, identifying defects in tires or split rims, and/or automating the detection of tire anomalies.

Other benefits and features of the present invention will become evident form the accompanying drawing and the Detailed Description hereinbelow.

### BRIEF DESCRIPTION OF THE DRAWINGS

FIG. 1 shows a side view of the tire cage 50 of the present invention, wherein the cage is secured about a tire 58.

FIG. 2 shows a side view of the tire cage 50 of the present invention, wherein the cage is open.

FIG. 3 shows a plan view of the bottom of the tire cage 50.

FIG. 4 shows the back or rear of the tire cage 50.

FIGS. 5A and 5B show more detailed views of the posts 118.

FIG. 6 is a top view of tire cage 50 when the cage is closed about a tire 58 as in FIG. 1.

FIG. 7 is a front view of lid 60.

FIG. 8 is a side view of the tire cage lid 60.

FIG. 9 shows the operator controls for operating the tire cage 50.

FIGS. 10A and 10B show more detailed views of the pedestal 156 upon which a tire 58 is provided within the cage 50.

FIG. 11 is a view top view of the lower table 164.

FIG. 12 shows a representation of a cross section of an embodiment of a metallic energy absorbing foam used for the blocks 264.

FIG. 13 shows a representation of a single cell 408 of a metallic energy absorbing foam used for the blocks 264.

FIG. 14 shows a side view of an embodiment of the tire cage 50, wherein tire imaging equipment, e.g., upper and lower video recording device assemblies 426 and 428, respectively, are shown mounted to the tire cage 50 thereby allowing an operator to view the tire 58 from an operator station 422 that may be safely remote from the tire cage.

FIG. 15 shows a top view of the tire cage 50 embodiment of FIG. 14.

FIG. 16 shows a bottom view of the tire cage 50 embodiment of FIG. 14.

FIG. 17 shows a side view of the upper video recording device assembly 426 mounted to the tire cage 50 as in FIG. 14. In particular, the present view is a view of the side 17V-17V of the dashed sectioning plane 17SP in FIG. 14.

FIG. 18 shows a side view (orthogonal to FIG. 17) of the upper video recording device assembly 426 mounted to the tire cage 50 as in FIG. 14. In particular, the present view is a view of the side 18V-18V of the dashed sectioning plane 18SP shown in FIGS. 14 and 17.

FIG. 19 shows a side view of the lower video recording device assembly 428 mounted to the tire cage 50 as in FIG. 14. In particular, the present view is a view of the side 19V-19V of the dashed sectioning plane 19SP in FIG. 14.

FIG. 20 shows a side view (orthogonal to FIG. 19) of the lower video recording device assembly 428 mounted to the tire cage 50 as in FIG. 14. In particular, the present view is a view of the side 20V-20V of the dashed sectioning plane 20SP shown in FIGS. 14 and 19.

FIG. 21 shows an embodiment one of the energy absorbing assemblies 254 (FIGS. 6, and 8), wherein there are a plurality of compression sensors 560 distributed between and/or about the subassemblies 262.

FIG. 22 shows an embodiment of one of the energy absorbing subassemblies 262.

FIG. 23 shows an embodiment of a sensor 560 for measuring compression of the energy absorbing subassemblies 262 after a tire explosion within the tire cage 50.

FIG. 24 shows an additional embodiments of the subassemblies 262 positioned in the energy absorbing assemblies 254.

FIG. 25 is a high level diagram showing the electronic and computational components of an embodiment of the tire cage 50.

FIG. 26 shows a representative graph of the deflection (e.g., compression of an energy absorbing subassembly 262) versus a load in kiloNewtons.

### DETAILED DESCRIPTION OF THE INVENTION

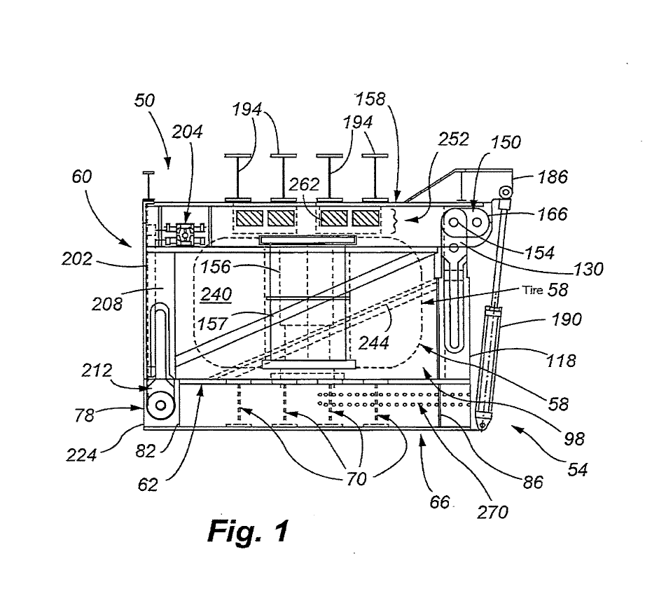

The embodiments of the tire cage 50 illustrated in FIGS. 1-11, and described hereinbelow are particularly suitable for safely containing an explosion of a conventional heavy equipment 8 foot diameter tire, i.e., suitable for safely containing an explosive impact force of up to 3500 to 3700 kiloNewtons (kN) and 1160 kiloJoules (kJ) of energy. Accordingly, for safely containing an explosion of a tire of a smaller or larger tire (more particularly, an explosion of a tire storing a substantially larger or smaller amount of energy) certain of the tire cage structural members described herein below, and the forces these members need to withstand may be substantially different from the dimensions provided herein. However, one of ordinary skill in the art will, from the description herein, be able to construct an embodiment of the tire cage 50 for such smaller or larger tires, bearing in mind that, in general, the energy stored in a tire exponentially increases with the diameter of the tire, as discussed in the Summary section hereinabove. Accordingly, embodiments of the present invention are readily applicable to very small tires (e.g., 12 inch diameter tires of a manually maneuverable wheelbarrow), conventional automobile tires, truck tires of various sizes as well as the large tires used in earth moving equipment (e.g., 6 to 12 feet in diameter).

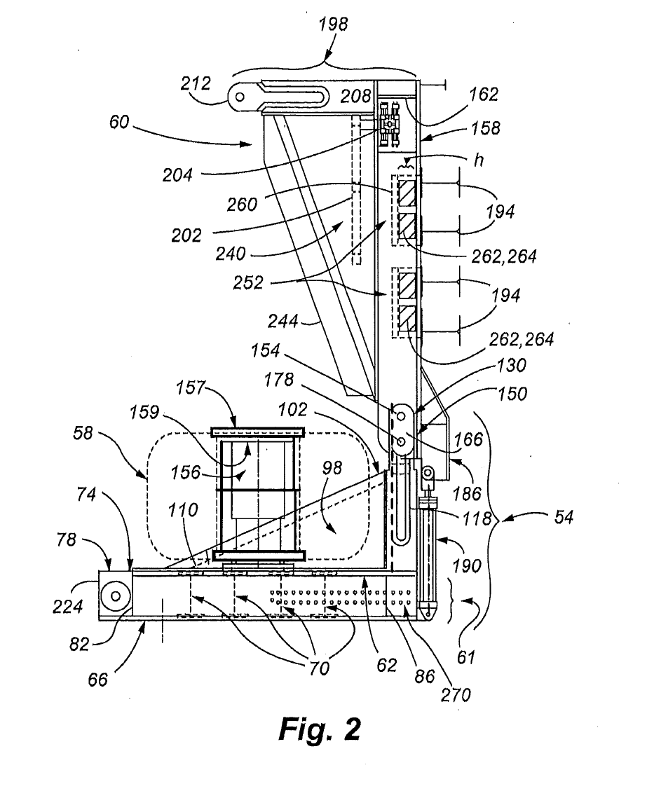

Referring to FIGS. 1 through 3, these figures show side and top views of the tire cage 50 of the present invention. The tire cage 50 includes: (a) a tire support assembly 54 for supporting a tire 58 placed within the cage 50, and (b) a pivotally attached lid 60. Each of the support assembly 54 and the lid 60 has a corresponding frame of steel beams and steel plates (as further described hereinbelow and shown in the figures), wherein these frame components are welded together to thereby provide the structural support for the tire cage 50. The tire support assembly 54 includes a support platform 61 (FIG. 2) that provides the support base for the remainder of the tire cage 50. The support platform 61 includes an inner support plate 62, and in some embodiments, an outer support plate 66 may be provided as well. However, in one preferred embodiment, there is no outer support plate 66 since by leaving the bottom of the support platform 61 open, greater accessibility is provided to tire cage cables, pipes, and electrical wiring provided underneath the inner support plate 62. In particular, in the embodiment without the outer support plate 66, the bottom of the tire cage 50 is made from large W-beams (not shown) welded together with a support plate 62 welded on top (thus allowing access underneath for cables, pipe, etc}, wherein this support plate is fixedly attached to (e.g., by welds) a plurality of “I” beams 70 (FIGS. 1, 2 and 4).

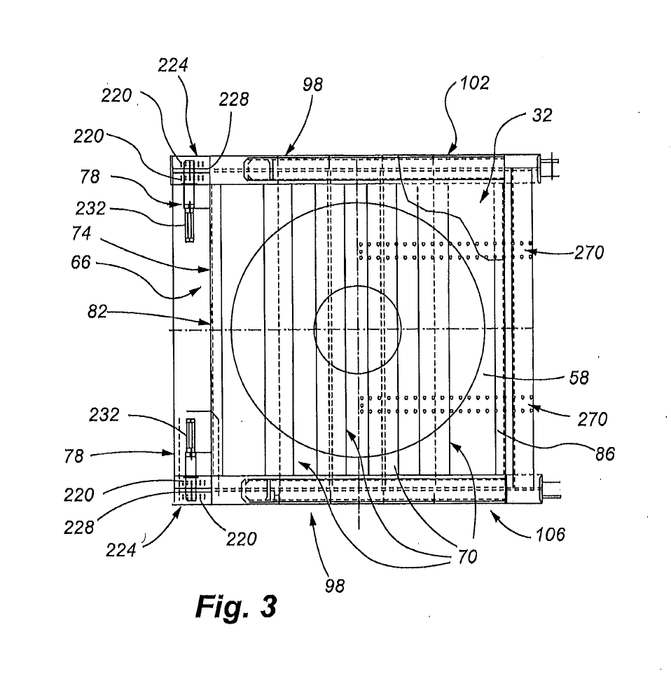

The support plates 62 and 66 (or instead of 66, the plate to which the W-beams are welded) are positioned on top of one another so as to have substantially vertically aligned outside perimeters when viewed from below (FIG. 3) with the exception that the inner support plate 62 is shorter along the front or latching side having an edge 74 (FIGS. 2 and 3). The shortened latching side of the inner support plate 62 is shorter by an amount effective for providing locking assemblies 78 for securing the lid 60 to the support assembly 54 when a tire 58 is being examined, inflated and/or deflated within tire cage 50. The support plates 62 and 66 (or instead of 66, the plate to which the W-beams are welded) are steel and are approximately twenty millimeters in thickness. The support plate 62, and the support plate 66 (or the plate to which the W-beams are welded) may be made from G40.21 50W grade steel. However, it is within the scope of the present invention that another sufficiently strong material may be used so long as it can withstand approximately 3700 kiloNewtons (kN) of force (e.g., for an 8 foot diameter tire) that can be generated by the explosion of a tire 58. Additionally, the “I” beams 70, in the present embodiment, are common structural members conforming to CSA G40.20 and CSA G40. To further stabilize the support assembly 54, various vertical stiffeners such as plates 82, and 86 are provided.

The support assembly 54 also includes two lower side members 98 (FIG. 1) which are mirror images of one another, wherein each projects diagonally vertically upwardly relative to the support plate 62. In the present embodiment, there are side edges 102 (FIGS. 1 and 3) and 106 (FIG. 3), wherein each is a steel plate approximately six millimeters thick with the exception of the upper most diagonal band 110 (FIG. 2) which is comprised of a HSS 102×203×4.8 structural member, as one skilled in the art will understand, this structural member is a tubular member having a rectangular cross section of 4 inches by 8 inches.

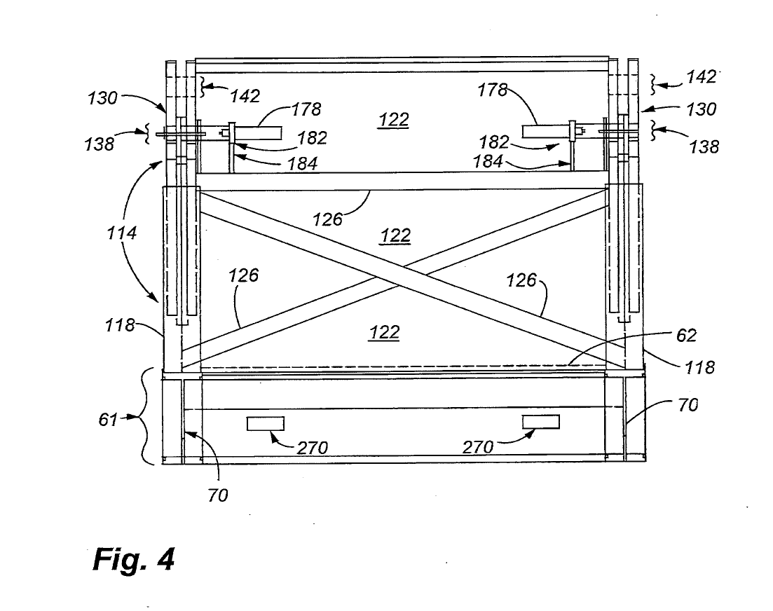

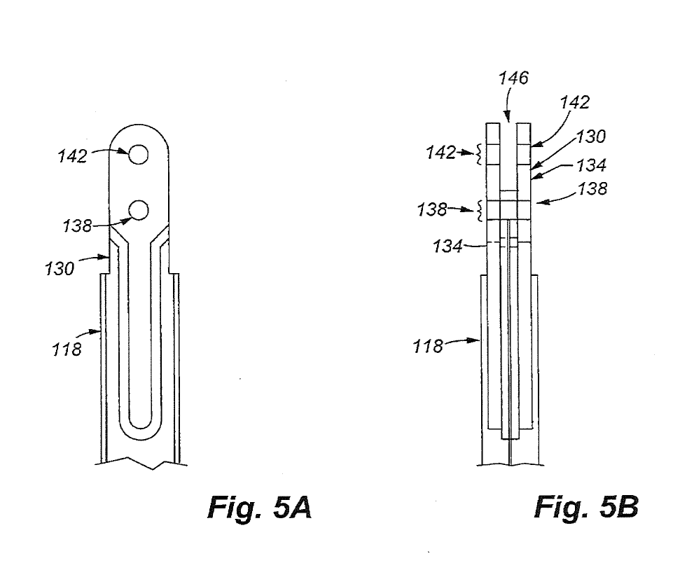

The support assembly 54 further includes a back assembly 114 (FIG. 4) that is secured to both the support platform 61 and the lower side members 98. The back assembly 114 includes posts 118 (FIGS. 1, and 4) welded to the support platform 61. Welded to each of the posts 118 is a back plate 122, which may be 6 mm G40.21 50W Grade Steel or another material of comparable strength. Note that back plate 122 is reinforced by cross members 126 for additional strength, these cross members being HSS 102×102×4.8 structural support members made of G40.21 50W Grade Steel (i.e., a steel tube having a 4 inch by 4 inch cross section) or another material of comparable strength. Attached to (or integral with) each of the posts 118 is a hinge assembly 130 (FIGS. 4, 5A and 5B) for pivotally attaching the lid 60 to the support assembly 54. Note that each of the hinge assemblies 130 includes a pair of hinge plates 134 (FIG. 5B) that extend to the top of the hinge assembly, and wherein these plates each have a hole 138 and a hole 142 therein, wherein: (i) the holes 138 are aligned with one another as shown in FIGS. 5A and 5B, (ii) the holes 142 are also aligned with one another as shown in FIGS. 5A and 5B, and (iii) at least the pair of holes 142 have a hinge slot 146 therebetween for the insertion of a mating hinge portion 150 (FIGS. 1, 2 and 8) of the lid 60. In particular, for each hinge assembly 130 and its mating hinge portion 150, these components are fitted together with a pivot pin 154 which is provided through the holes 142 and a corresponding aligned hole in the hinge portion 150 so that the lid 60 can pivot on this pivot pin between the fully closed configuration shown in FIG. 1 and the fully open configuration shown in FIG. 2.

The support assembly 54 also includes a tire pedestal 156 (FIGS. 1 and 2) that is secured to the upper surface of the support plate 62. The tire pedestal 156 is for supporting a tire 58 in a properly aligned orientation within the tire cage 50, as one skilled in the art will understand. In particular, the split rim 157 for the tire 58 (symbolically represented in FIGS. 1 and 2 by the heavy lined profile in the center of the tire 58) is aligned on the pedestal 156 so that if a tire malfunction occurs such that one or more portions of the split rim are propelled toward the cage 50 at high velocity, then it is intended that such rim portions will be propelled substantially vertically upwardly toward the inside of the lid 60 as will be discussed further hereinbelow.

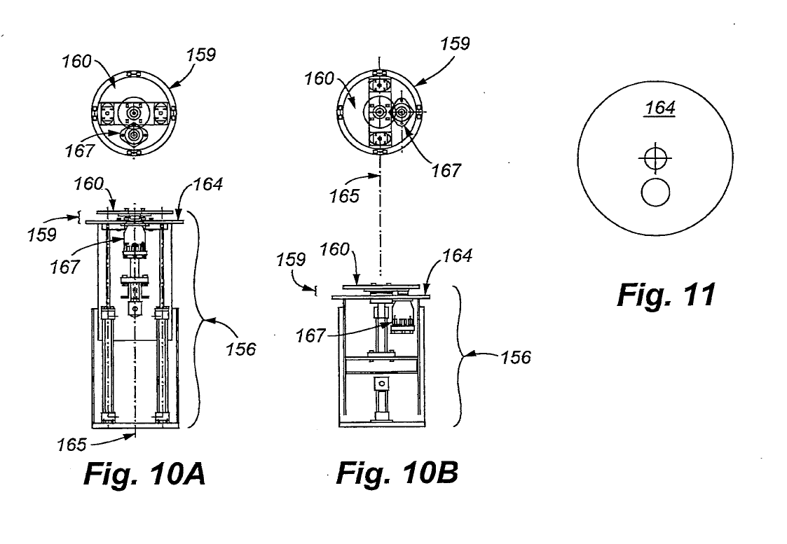

The tire pedestal 156 includes a hydraulic adjustable height table 159 (FIGS. 1, 10A-10B). The table 159 includes a tire support center 160 and a lower table 164 (also FIG. 11). The tire support center 160 is rotatable about the central axis 165 of the generally cylindrical pedestal 156, wherein a motor 167 that is used to rotate the tire support center about the central axis. Accordingly, when a tire 58 is initially positioned in the tire cage 50, the tire pedestal 156 is in the lowered position of FIG. 10B, and subsequently an operator activates hydraulics of the tire cage to raise the table 159 and rotate the tire support center 160 for inspection of the tire 58 during inflation/deflation as one skilled in the art will understand.

Note that the tire pedestal 156 (as well as the rest of the tire cage 50) is configured so that tires smaller than the largest acceptable tire may be safely inflated and/or deflated in the tire cage. In particular, an embodiment of the tire cage 50 according to the disclosure herein may be used for safely inflating and/or deflating tires having diameters of 3 and 6 feet.

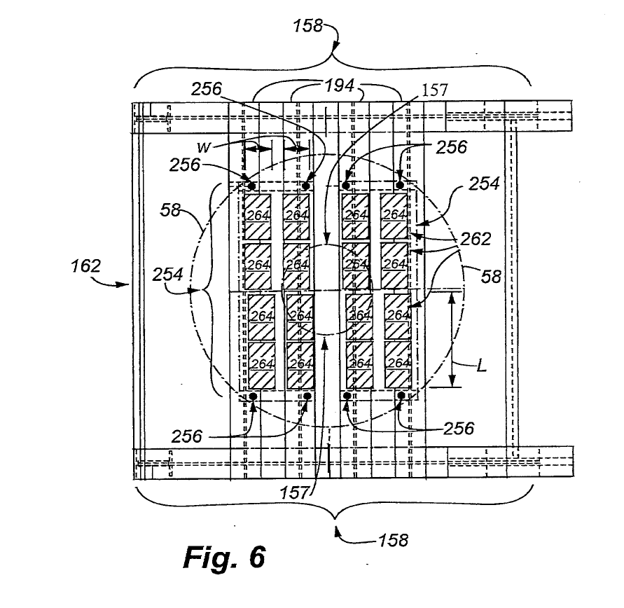

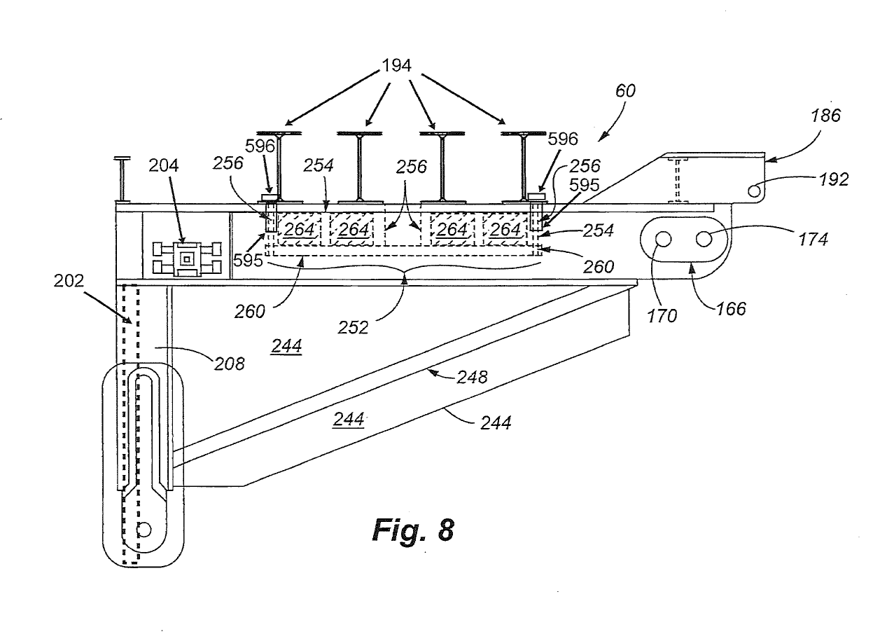

Referring to lid 60, it includes two side beams 158 (FIGS. 1, 6, 7 and 8) that extend substantially the length of the lid along its sides. The front end of each of the side beams 158 is attached to a front cross “I” beam 162 (FIG. 6) that extends across the width of the lid 60, and the rear of each of the side beams 158 has attached thereto a corresponding one of the hinge portions 150 (FIGS. 1 and 2). Note that each of the hinge portions 150 includes a pair of bearing plates 166 (FIGS. 1 and 2) attached to opposing sides of the corresponding side beam 158. Each of the bearing plate 166 has two holes 170 and 174 (FIGS. 1 and 8) therein that also extends through the hinge portion 150 (including the side beam 158 to which it is attached). The hole 170 is the hole through which the pivot pin 154 is provided as described hereinabove. Thus, the portion of each bearing plate 166 surrounding its hole 170 includes bushings (not shown) upon which the pivot pin 154 seats for smooth pivotal movement of the lid 60. The hole 174 is for securing the lid 60 in the open position as shown in FIG. 2. Accordingly, when the holes 174 are aligned with the holes 138 such that the lid 60 is in the upright or open position of FIG. 2, there is, for each post 118, a safety pin 178 (FIGS. 2 and 4) for entering and engaging both the hole 174, and the pair of holes 138 in the hinge assembly 130 for the post so that the lid 60 is securely held in the open position. Note that the safety pins 178 are moved between the unengaged positions of FIG. 4 to the engaged position of FIG. 2 by corresponding actuators 182 that are attached, via a mounting plate 184, to one of the back plate support frames 126. Note that the actuators are preferably hydraulic; however, other types of actuators are also within the scope of the present disclosure, including electric and pneumatic.

On top of the rear of each of the side beams 158 is a lever beam 186 to which a hydraulic actuating cylinder 190 (FIGS. 1 and 2) is attached in hole 192 (FIG. 8) for pivotally moving the lid 60 between its open and closed positions.

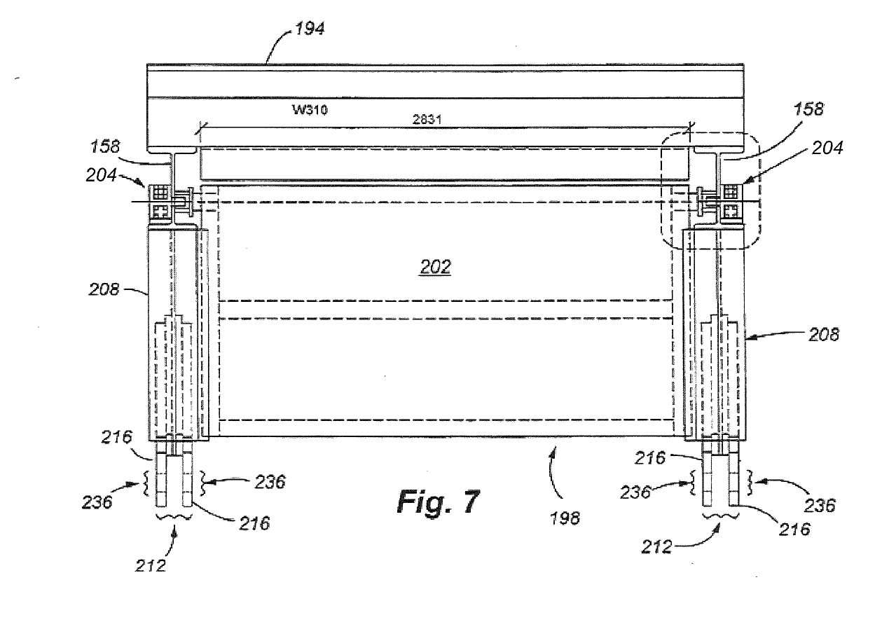

Across the width of the lid 60 and attached to the side beams 158 are a plurality of impact beams 194 (FIGS. 7 and 8) that are W460×120 structural members conforming to CSA G40.21, as one skilled in the art will understand (note that a description of CSA G40.21 may be found at www.csa.org).

FIG. 7 best shows the front 198 of the lid 60. The front 198 includes a retractable front plate 202 (FIGS. 1, 2, and 7) which may be a steel plate of approximately 6 millimeters thickness. In an extended position, the front plate 202 entirely covers the front 198 when the lid 60 is in the closed position (FIG. 1). In a retracted position, the front plate 202 is substantially parallel to the cross beams 194 and the side beams 158 (FIG. 2) when the lid is in its open position. The front plate 202 is moved between its extended and retracted positions by an actuator 204 (FIGS. 1, 2, and 8). Note that by having the front plate 202 in a retracted position (FIG. 2) when the lid 60 is open, it is much easier to properly place a tire 58 within the tire cage 50. This is particularly important due to the sizes and weights of the tires 58 to be used with the present invention (e.g., tires having a diameter of 6 to 12 feet, and weighing upwards of 2500 lb), since a crane or other similar lifting equipment must be used to hoist the tire 58 above the support assembly 54 and then the tire must be aligned on the tire support pedestal 156 by one or more operators. Thus, the overhead clearance afforded by the present invention in combination with the ease of operator access to a suspended tire 58 due to the front 198 having no walls or barriers is a distinct advantage offered by the present invention.

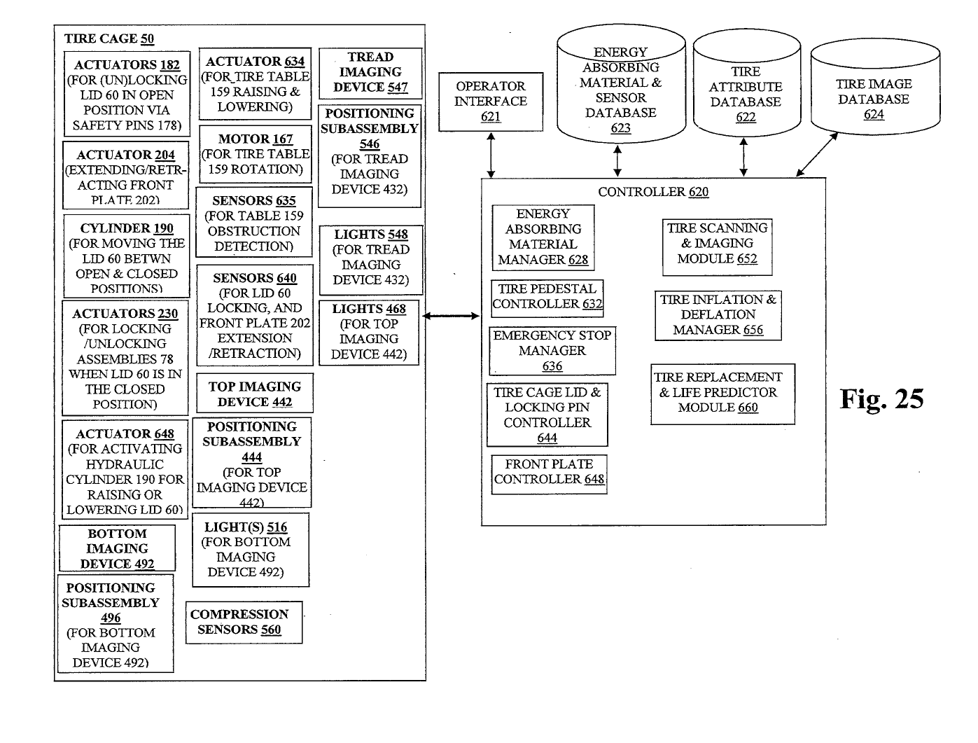

Two lid posts 208 are additionally provided at the corners of the front 198, wherein each of the posts 208 is attached to one of the side beams 158. Each of the lid posts 208 has extending therefrom a bifurcated connector 212, wherein each of the extensions 216 (FIG. 7) of the connector is received over a corresponding one of the bosses 220 (FIG. 3) in a corresponding one of the locking assemblies 78. In particular, each of the locking assemblies 78 includes a locking enclosure 224 (FIGS. 1-3) having a center steel plate 228 (FIG. 3), wherein there is one of the bosses 220 on each side of the plate 228 and adjacent thereto. Thus, when the lid 60 is in its closed position, each of the connectors 212 can be locked to the support assembly 54 by an actuator 230 (identified in FIG. 25) of the locking assembly 78. In particular, for locking each connector 212 to the support assembly 54, the actuator moves a pin 232 of the locking assembly 78 through the holes 236 (FIG. 7) of each extension 216 of the connector and also through a hole (not shown) in the plate 228 therebetween when the connector is fully received in the corresponding one of the locking enclosures 224. Conversely, for unlocking the lid 60 from the support assembly 54, the actuator of the locking assembly 78 retracts the pins 232 from the holes 236 so that by activating the actuating cylinder 190, the lid 60 can be raised into its open position, and the safety pins 178 can then be moved into holes 138 to lock the lid in the open position.

The lid 60 further includes lid sides 240 (FIGS. 1 and 2), wherein each of the lid sides is approximately 6 millimeters in thickness of steel plate. Each lid side 240 is attached to a corresponding one of: the side beams 158, and a corresponding one of the lid posts 208, such that each side 240 is substantially vertically aligned with and overlaps one of the lower side members 98 when the lid 60 is in its closed position. In particular, a diagonal portion adjacent edge 244 overlaps the corresponding one of the side beams 158 as shown in FIG. 1. Additionally, note that each of the lid sides 240 includes a diagonal reinforcement beam 248 (which may be of type HSS 102×203×4.8, as one skilled in the art will understand) for providing additional strength to the lid sides 240.

The lid 60 also includes an energy absorbing structure 252 (FIGS. 1 and 8) for absorbing blast energy from a tire 58 that malfunctions. In particular, when the cage 50 is closed, the energy absorbing structure 252 absorbs energy from portions of the split rim 157 wherein such portions are propelled vertically toward the cross beams 194 such that these cross beams are able to withstand the remainder of a tire blast force without deformation. The energy absorbing structure 252 includes a plurality of energy absorbing assemblies 254 (FIGS. 6, and 8), each such assembly being separately anchored to the cross beams 194 by a plurality of anchors 256, such that these assemblies 254 are spaced apart from one another (such spacing facilitates the expelling of the large air pressures that can develop within the cage 50 when a tire malfunctions). Depending upon the embodiment of the invention, there may be only two such assemblies 254 (e.g., as shown in FIG. 6 in dash-dot-dash outline), wherein each one of the assemblies extends across at least a sufficient amount of the center of the cage immediately above the split rim 157 so that it is unlikely that a portion of this rim can contact the cross beams 194, and it is also unlikely that any portion of the split rim will exit the cage 50. However, other arrangements and sizes of such assemblies 254 are within the scope of the invention. For example, in some embodiments there may be a larger number of such assemblies 254 occupying substantially the same or a greater area than the assemblies 254 of FIG. 6.

Each of the assemblies 254 includes a 2 to 2½ inch thick steel plate 260 (FIG. 2) (also known as a “decoupler plate” herein), wherein the plate may be approximately 28 inches by 74 inches. Each decoupler plate 260 is suspended from the cross beams 194 by the anchors 256 such as threaded steel rods. Between each of the plates 260 and the cross beams 194 are one or more energy absorbing subassemblies 262 (FIG. 6) for each assembly 254, wherein the subassemblies 262 are for absorbing the forces imparted from an exploding tire 58. Although not all subassemblies 262 are labeled in FIG. 6, there are sixteen such subassemblies, one for each of the sixteen blocks 264 shown in FIG. 6. Each of the subassemblies 262 (FIG. 22) includes a block, pad, or layer 264 (for simplicity denoted herein as “block”, and crosshatched in FIGS. 1, 2, 6, and 8) of an energy absorbing material that permanently deforms when absorbing the kinetic energy from, e.g. an exploding tire. Each subassembly 262 also includes two metal plates 266. One of the metal plates is bonded to (and covers) the side of the subassembly block 264 wherein this side faces the decoupler plate 260. The other of the metal plates is bonded to (and covers) the opposing side of the block 264 that faces the cross beams 194. In one embodiment, such metal covering plates protect the blocks 264 from damage during shipping, and installation into the assemblies 254. Additionally, for each block 264, its covering plates may provide additional support during tire explosion. In addition, the covering plates and the block 264 for a subassembly 262 are coated with a non-corrosive material to prevent deterioration of the block 264. In at least some embodiments, the non-corrosive material is a chemically applied film of Class 1A gold.

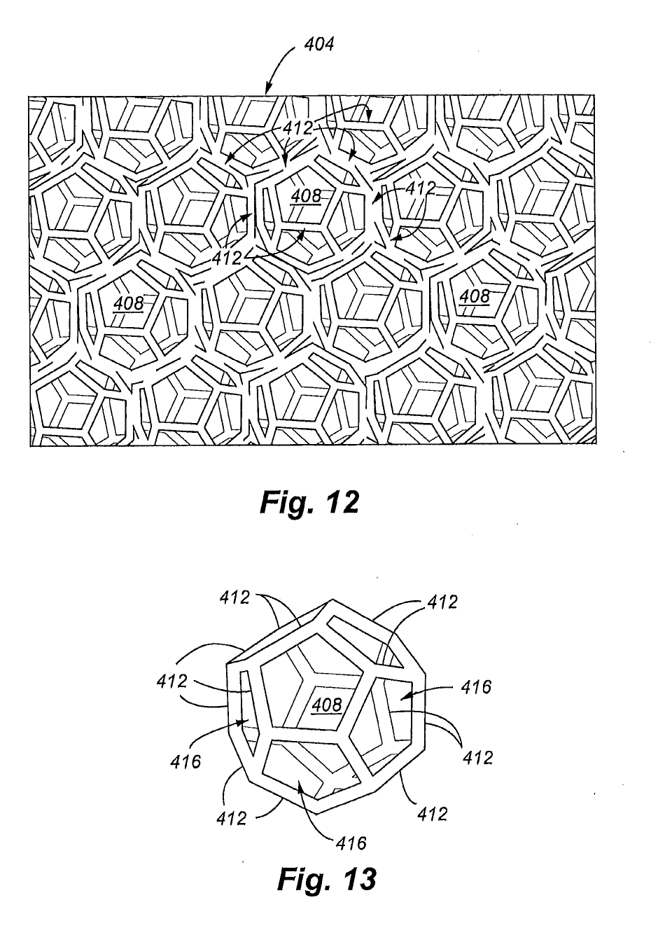

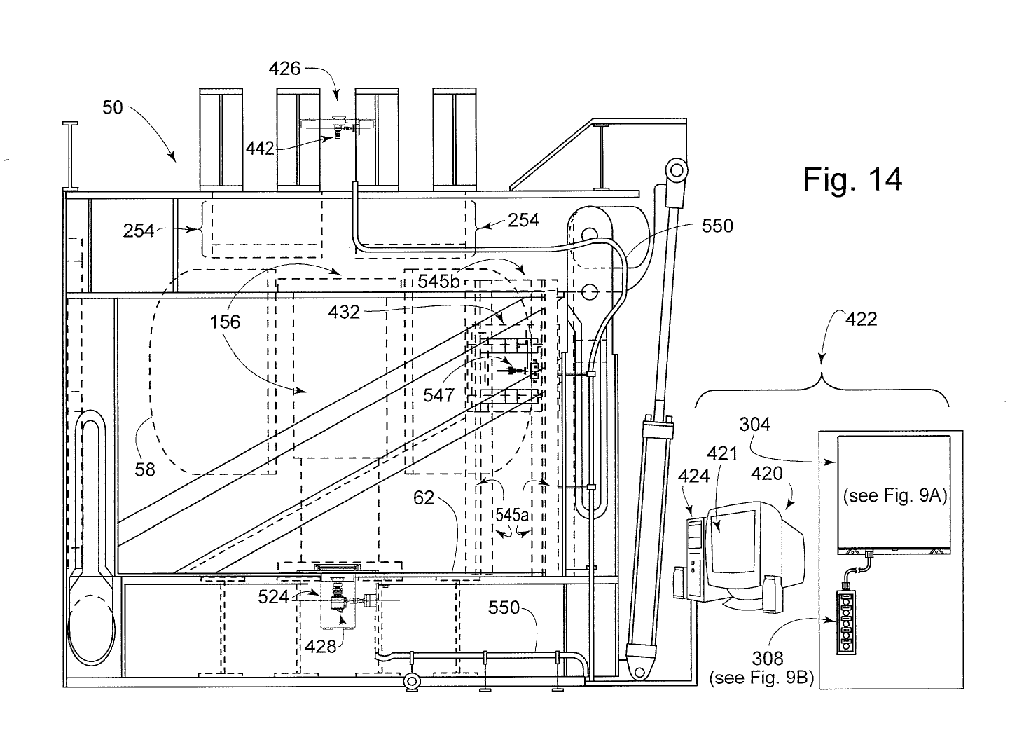

In one embodiment, each block 264 includes (and may substantially consist of) a rigid energy absorbing material such as what is known in the art as an “open celled foam” material (also denoted herein as simply “foam”). A highly magnified portion 404 of a representation of such a foam is shown in FIG. 12. In particular, such open celled foams include a large plurality of small air filled spaces 408 (denoted cells herein), wherein each of the cells 408 is defined by a plurality of small rods 412 of the foam material in a manner whereby the rods connect together to form open polygonal structures such as, e.g., pentagons or hexagons. One such representation of a cell 408 is shown in FIG. 13. The open polygonal structures form faces 416 of the 3-dimensional cells 408. Generally there are 12 to 14 such faces defining the boundary of a cell 408, and since most of the faces 416 define a portion of the boundary for at least two cells, such rigid open celled foam materials appear upon magnification as similar to a 3-dimensional honeycomb-like structure, as one skilled in the art will understand. Such open celled foam materials may be characterized by: (a) the material of the rods 412, (b) the relative density of the foam, (c) the face size(s), (d) the rod size(s), and (e) the cell shape(s) as one skilled in the art will understand. However, for absorbing energy, the primary strength characteristics are generally (a) and (b) above. Such foams are particularly effective in absorbing high-energy forces in that these foams will structurally deform their cells when impacted by an object and thereby prevent the transfer of energy beyond the foam. The energy absorbing blocks 264 for the present invention may have their rods made substantially of aluminum, an aluminum alloy (e.g., aluminum alloys 6101 or A356 as one skilled in that art will understand), or another metallic alloy such as a nickel or copper alloy. In at least some embodiments of the invention, the blocks 264 are formed from Duocel Aluminum Foam manufactured by ERG Materials and Aerospace Corp., located at 900 Stanford Ave., Oakland, Calif., USA, 94608.

Note that in at least one embodiment of the invention, one or more of the blocks 264 may include a plurality of layers of an energy absorbing material, and in particular, various layers of one or more metallic foams. Having a plurality of layers for one or more of the blocks 264 allows better control in absorbing forces from a tire explosion. In particular, the size, location, and energy absorbing characteristics of the layers within the blocks 264 may be varied. For example, different layers may be fabricated from different metallic foams, from foams of a different relative density, from foams of a different thickness and/or from foams with different crushing characteristics. Moreover, the layers may be layered upon one another in a particular sequence for enhancing the energy and force absorbing characteristics of the blocks 264. For example, a relatively low crush strength foam layer may be the layer contacting the decoupler plate 260 with additional layers having progressively higher crush strengths. Thus, in the event that one of the assemblies 254 is not as forcefully impacted during a tire explosion, it may be that only the layer contacting the decoupler plate 260 must be replaced.

As shown in FIG. 6, substantially the entire surface of a decoupler plate 260 for supporting the blocks 264 (or the subassemblies 262), may be covered by the blocks. All such blocks 264 preferably have the same dimensions and energy absorbing capability for a given embodiment of the tire cage 50. However, such block dimensions and energy absorbing capabilities may be different between embodiments of the tire cage 50, depending, e.g., on the explosiveness (stored energy) in the tires to be provided in the tire cage 50. Moreover, note that certain advantages are obtained by providing a larger number of small subassemblies 262 such as shown in FIG. 6. In particular, if a tire 58 (and its split rim 157) explodes within the cage 50, it can be that not all of the subassemblies 262 are deformed by the blast. Thus, only those subassemblies 262 affected by the blast need be replaced. In the Appendix hereinbelow, tables are provided identifying various arrangements and densities of foam blocks forming the subassemblies 262, wherein the cross sectional area (parallel to the support surface of the decoupler plate 260) of the foam blocks within each subassembly 262 ranges from 24.5 to 36 in², and wherein the subassemblies are arranged in various configurations, and have different relative densities ranging from 6.3 to 11.3%. The Appendix tables illustrate that a wide range of subassembly 262 arrangements, sizes, and block 264 densities can be used within the tire cage 50 to absorb at least approximately a tire 58 explosion force of 3500 to 3700 kiloNewtons (as described further in the Appendix hereinbelow), and to absorb approximately 1160 kilojoules (855,853 ft-lbs) of kinetic energy from, e.g., a flange and bead seat band of a split rim tire propelled toward the tire cage 50. Also, note that the collection of subassemblies 262 may extend the entire width of the cage 50, or they may be oriented 90 degrees to the orientation in FIG. 6. Additionally note that the assemblies 254 may be spaced differently for different embodiments.

Since the present invention contemplates that the energy absorbing structure 252 should, in at least one embodiment, be capable of absorbing the force of approximately 3500 to 3600 kiloNewtons of force imparted to the bead seat band/side ring and lock ring of, e.g., a 96 inch diameter split rim tire 58, the use of such an energy absorbing foam provides the only known way to absorb this amount of force within, e.g., a relatively small volume (e.g., a volume corresponding to the space in the closed cage 50 above the tire 58, wherein the distance between the cross beams 194 and the tire 58 is in the range of 12 to 20 inches), and wherein the cage is not so heavy that it becomes difficult to transport with, e.g., a forklift. In particular, it is desirable that the cage 50 be less than approximately 10-15 tons. Additionally, such foams are the only known materials that can absorb such high forces and still be lightweight. Each of the subassemblies 262 may weigh between 10 and 20 pounds. Thus, in one embodiment, their relative contribution to the weight of the tire cage 50 is approximately less than 2% of the approximate tire cage weight of approximately 7 tons. Moreover, it is believed that if such a light energy absorbing material were not used, the resulting tire cage could weigh as much as 15 tons, require twice the volume for operation, and thus would be very difficult to move between locations without, e.g., dismantling. In particular, it is worthwhile to note that the support assembly 54 may include channels 270 through the “I” beams 70 so that a forklift can transport the tire cage 50 by inserting the forks of the forklift into these channels. Note that in one embodiment, the channels 70 may be enclosed by steel plates for the channel sides, wherein these plates pierce the “I” beams and are welding thereto.

As mentioned above, various arrangements and relative densities of Duocel manufactured energy absorbing aluminum blocks 264 (more precisely, the subassemblies 262) have been determined to be effective in absorbing a force of approximately 3500 to 3600 kiloNewtons (equivalently, approximately 786,795 to 809,275 lb-ft). Representative arrangements are provided in the Appendix. It is preferred that each of the blocks 264 have a width “w” (FIG. 6) and a length “L” of at least 4 inches. However, it should be noted that, depending on the relative density, crushing properties (i.e., crushing plateaus between 190-538.9 psi), and material used to fabricate the foam, the blocks 264 may have virtually any length and width ranges that can be accommodated within the tire cage 50. Additionally, it is preferred that each block 264 have a ratio of thickness “h” (FIG. 2) to the smaller of the width “w” and length “L” of no more than 2:1. Accordingly, for blocks 264 (or subassemblies 262) where “h” is eight inches, both the width “w” and the length are at least four inches.

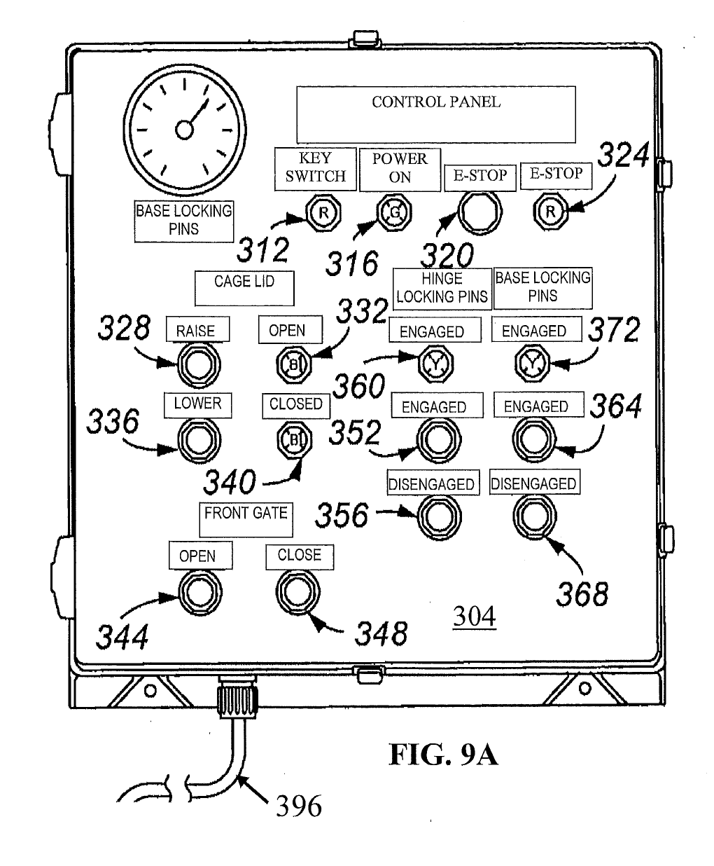

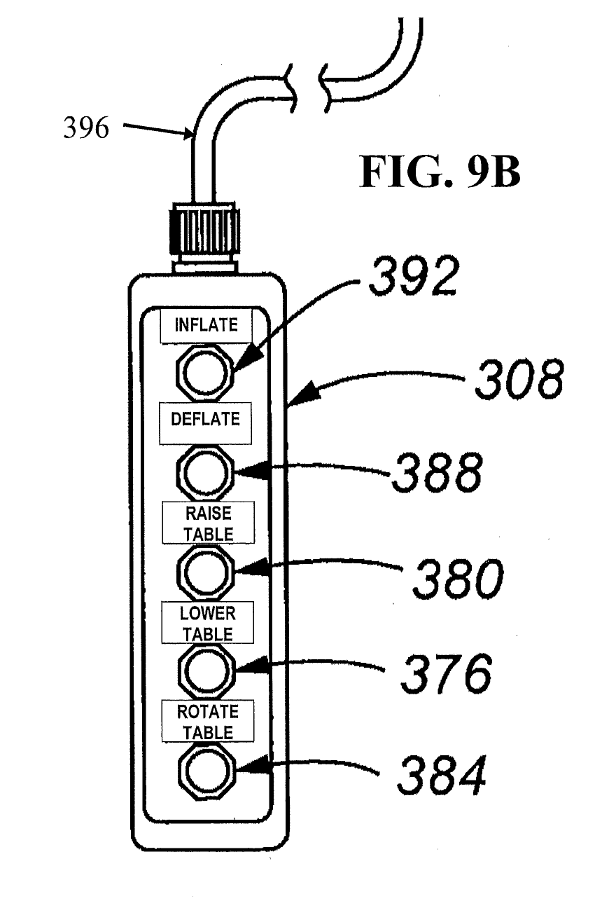

The tire cage 50 also includes an electronic control subsystem for controlling lid 60 positioning and the inflating of a tire 58. FIG. 9 shows an illustrative embodiment of the operator controls for the tire cage. In particular, there is an operator console 304 that may be fixedly attached to tire cage 50 on, e.g., a side thereof, wherein this console includes all of the operator controllable functions for operating the tire cage 50. In addition, a portable controller 308 is operably connected to the console 304. Accordingly, an operator can access most of the functionality to control the tire cage 50 via the controller 308 while walking around the tire cage and/or staying a safe distance therefrom. The following are brief descriptions of the operator controls shown in FIG. 9:
(a) A key switch 312 for inserting a key to operate the tire cage 50.
(b) A power on light 316 indicating whether there is electrical power to the console 304.
(c) An emergency stop button 320 for stopping movement of the lid 60 and/or inflation of a tire 58.
(d) An emergency stop light 324 such that when the button is pushed, shows that an emergency stop has been activated.
(e) A raise lid button 328 such that when the button is pushed, the lid 60 raises toward the lid position of FIG. 2.
(f) An indicator light 332 for indicating when the lid 60 is fully raised in the open position.
(g) A lower lid button 336 such that when the button is pushed, the lid 60 lowers toward the lid position of FIG. 1.
(h) An indicator light 340 for indicating when the lid 60 is fully lowered onto the tire support assembly 54.
(i) A button 344 such that when the button is pushed, the front plate 202 retracts toward its position in FIG. 2.
(j) A button 348 such that when the button is pushed, the front plate 202 extends toward its position in FIG. 1,
(k) A hinge locking button 352 such that when the button is pushed, the actuators 182

(FIG. 4) are activated for moving the safety pins 178 from their positions as shown in FIG. 4 to positions of being seated in their corresponding hole 138 of a post 117 and corresponding hole 174 of the lid (FIG. 8).

(l) A hinge unlocking button 356 such that when the button is pushed, the actuators 182 (FIG. 4) are activated for moving the safety pins 178 from their locked positions (wherein these pins are seated in their corresponding hole 138, and corresponding hole 174) to their positions as shown in FIG. 4.
(m) An indicator light 360 for indicating when the lid 60 locked into the position of FIG. 2.
(n) A support assembly locking button 364 such that when the button is pushed, the (hydraulic) locking assemblies 78 (FIG. 3) are activated for moving the pins 232 from their positions as shown in FIG. 3 to positions of being seated in their corresponding hole 236 (FIG. 7) of the lid 60 and corresponding boss 220 of the support assembly 54 (FIG. 3).
(o) A support assembly unlocking button 368 such that when the button is pushed, the hydraulic locking members 78 (FIG. 3) are activated for moving the pins 232 from their locked positions (wherein these pins are seated in their corresponding hole 236 (FIG. 7), and corresponding boss 220 (FIG. 3)) to their positions as shown in FIG. 3,
(p) An indicator light 372 for indicating when the lid 60 is locked to the support assembly 54.
(q) A button 376 on the controller 308, such that when the button is pushed, the button lowers the table 159 (by hydraulics or other well-known techniques such as pneumatics, screw jacks and electro/mechanical actuators, etc.).
(r) A button 380 on the controller 308 for raising the table 159 when the button is pushed.
(s) A button 384 on the controller 308 for rotating the tire support center 160 inspection of the tire when the button is pushed.
(t) A button 388 on the controller 308 for deflating a tire 58 when the button is pushed.
(u) A button 392 on the controller 308 for inflating a tire 58 when the button is pushed.

To operate the tire cage 50, a tire 58 must be positioned on the tire pedestal 156 as shown in, e.g., FIGS. 1 and 2. Accordingly, to provide the tire 58 in this position, the lid 60 must in the position shown in FIG. 2 with the safety pins 178 (FIG. 4) seated within their corresponding holes 138 of each of the posts 118 and their corresponding holes 174 in the lid. Additionally, the front plate 202 should also be in its retracted position as shown in FIG. 2, and the pedestal 156 should be in its lower position (FIG. 10B). Subsequently, a tire 58 that is suspended in the air via, e.g., a hoist (not shown) lowers the tire onto the pedestal 156. Once the tire 58 is positioned on the pedestal 156, the table 159 can be raised (via button 380) so that the tire is supported on the support center 160. The tire support center 160 can then be rotated (via button 384) for inspection. Note that the control subsystem will not allow the tire 58 to be inflated or deflated unless the cage 50 is fully secured about the tire. Accordingly, the operator must disengage the safety pins 178 from their corresponding holes 174 in the lid 60 (via the button 356), and then lower the lid 60 (via button 336) by activating the hydraulic cylinder 190. Additionally, the operator must extend the front plate 202 (via button 348) so that when the lid 60 is in the position of FIG. 1, the front plate is also in the position shown in this figure. The operator then locks the lid 60 to the support assembly 54 via the button 364, and may then commence inflating or deflating the tire 58.

During the inflation or deflation process, the tire 58 may explode thereby propelling tire fragments in various directions, and in particular, portions of the split rim 157 may be propelled toward the lid 60. Upon impact by a portion of, e.g., the split rim 157 during a tire 58 explosion, each plate 260 disperses the impact of the various portions of the tire 58 (and in particular portions of the split rim 157) the over the subassemblies 262 that reside between the decoupler plate 260 and the cross beams 194. Accordingly, the kinetic forces of the tire fragments projected toward the lid 60 are effectively absorbed by the even distribution of such blast forces on the subassemblies 262 which would otherwise not occur if there were no decoupler plate 260. Additionally, the plate 260 acts as a large kinetic energy reflecting mass to “decouple” at least a portion of the kinetic energy, e.g., of the split rim 157 during tire explosion, from being transmitted to the subassemblies 262. Note that the decoupler plates 260 are reusable in subsequent tire explosions.

Note that after a tire explosion has occurred within the tire cage 50, the cage may then be opened and the remnants of the tire and its split rim 157 can be removed. Since most of the blast impact was absorbed by the energy absorbing structure 252, the remainder of the tire cage 50 is reusable by replacing the damaged portions of the energy absorbing structure. In particular, one or more of the anchors 256, and one or more of the subassemblies 262 will likely require replacement. However, the tire cage 50 is constructed so that such replacement being relatively straightforward.

### Operator Control Station and Tire Imaging Equipment.

Various enhancements to the above tire cage embodiments, and/or additional embodiments are also considered to be within the scope of the present disclosure. In particular, an embodiment of the tire cage 50 may include various devices for assisting an operator in inspecting a tire 58 within the cage. Such inspection devices may include tire imaging equipment such as one or more cameras, video recording devices, and/or microwave or x-ray devices, wherein such inspection devices may provide images (or other data) of various portions of a tire within the tire cage 50 so that, e.g., prior to inflation or deflation, a tire cage operator can inspect the tire 58 more effectively, efficiently and/or safely than by, e.g., walking around the tire and possibly climbing on the tire cage in order to inspect the tire therein. In particular, such inspection devices may communicate their images (or other inspection data) to one or more video or displays 421 monitors 420 (FIG. 14) at, e.g., an operator station 422 safely remote from the tire cage 50, wherein the operator can view such images (or other inspection data) on these monitors. In some embodiments, the operator may use controls at the operator station 422 to raise, lower and/or rotate the tire 58 positioned on the tire pedestal 156 for obtaining such inspection data, and viewing such data on the monitors 421 (such monitors may be, e.g., computer monitors, video monitors, closed circuit television-type display devices, or the like, and shall be referred to herein as “display monitors” or simply “monitors”).

Referring to FIG. 14, this figure shows an embodiment of the tire cage 50 (substantially as described above) with the operator station 422 having at least one computer 424 operably connected to one of possibly a plurality of display monitors 421, wherein the computer 424 and the monitor(s) 420 (via the display(s) 421) allow the operator to view or inspect various portions of the tire 58, and in one embodiment, multiple views of the tire simultaneously if desired. The station 422 may include an embodiment of the control console 304 (FIG. 9A) together with an embodiment of the controller 308 (FIG. 9B). However, in one or more embodiments both the control console 304 and the controller 308 may be implemented as one or more interactive graphics applications to be displayed on one of the monitors 420, optionally in combination with operator controls being provided via one or more operator input devices such as a computer mouse, trackball or joystick. In some such embodiments, the resulting graphical displays may represent each of: the console 304 and the controller 308 substantially as shown in FIGS. 9A and 9B such that their controls correspond to activatable areas of a display 421 for thereby providing the same functionality as described above for the console 304 and the controller 308. However, as one of ordinary skill in the art of computer interactive graphical displays will understand, various alternative graphical interface embodiments may be provided. Moreover, by providing the console 304 and the controller 308 as graphical interactive user applications, additional features can be more easily added to assist the operator and/or to provide additional safety features such as checks to assure that important portions of the tire 58 have been imaged or inspected by the imaging/inspection equipment. For example, inflation and/or deflation of a tire 58 may be prevented until the tire has been rotated at least one full 360 degree rotation on the pedestal 156 with the imaging/inspection equipment active for obtaining data/images of, e.g., the entire visible portion of the split rim 157, the tire 58, and/or the contact between the two. Moreover, such tire and split rim data/images may be archived for, e.g., operator training, recording the condition of a tire 58 (e.g., before it explodes), identifying defects in tires or split rims, and/or automating the detection of tire 58 anomalies. Additionally, the operator controls 392 and 388 for inflating and deflating the tire may be restricted to maximum rates and/or protocols that are deemed more safe, wherein tire inflation and deflation rates, pressures and/or durations may be substantially computer controlled instead of operator controlled. In one embodiment, a tire 58 may be inflated and/or deflated in a stepped protocol within the tire cage 50, wherein the tire is inflated/deflated to a first pressure, held at the first pressure for a predetermined time and/or until the tire is reimaged by the tire imaging equipment (preferably, imaging at least an entire circular juncture between the tire's split rim and the remainder of the tire 58). In another embodiment, such a tire inflation/deflation protocol may include repeated steps of alternately inflating followed by at least a partial deflation, or a deflation followed by a partial re-inflation. Other such inflation/deflation protocols are also within the scope of the present disclosure.

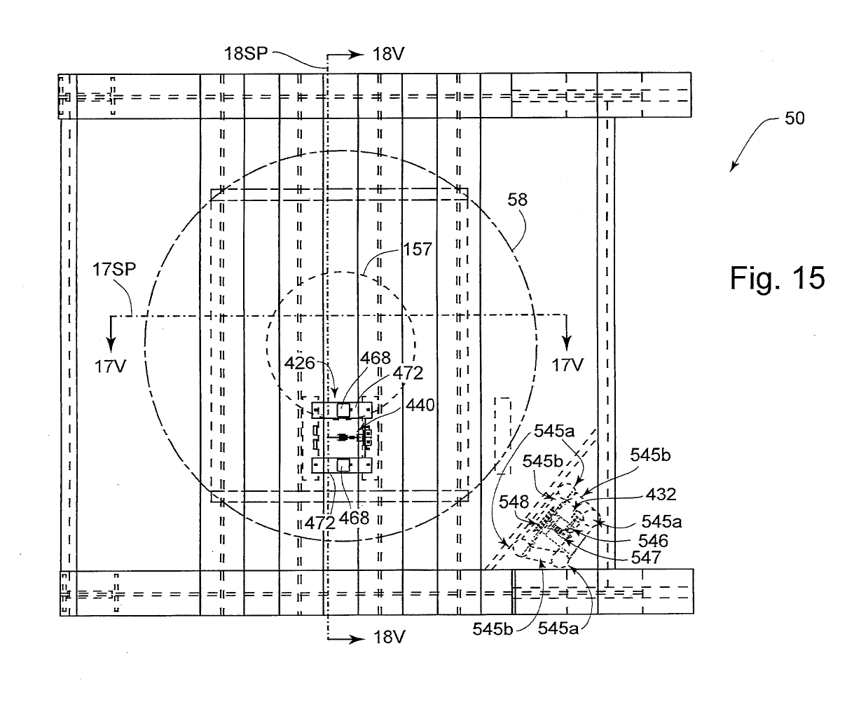

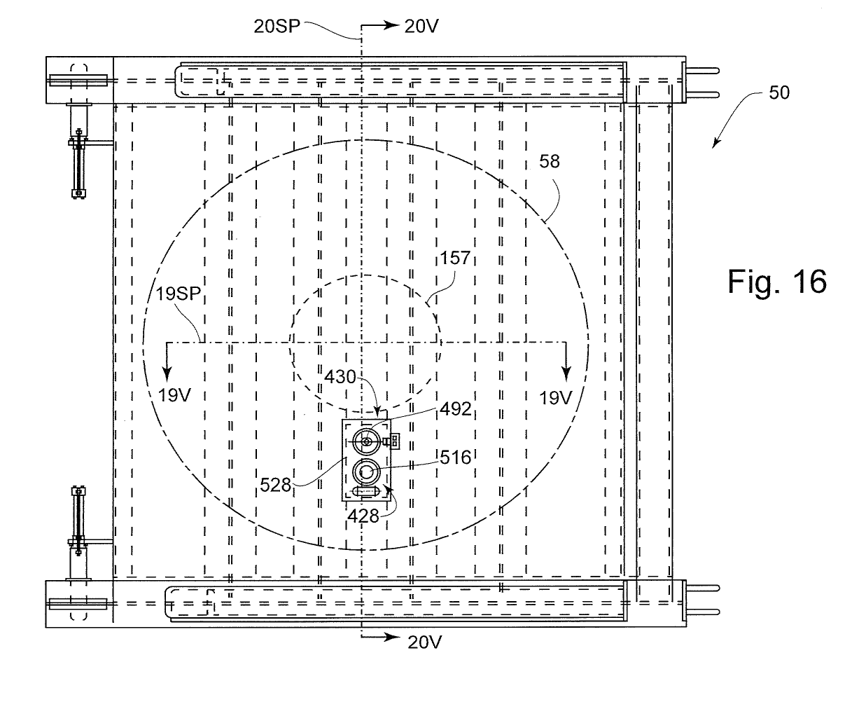

Referring to FIGS. 14-16, imaging equipment in the form of upper and lower image recording device assemblies 426 and 428 are shown mounted to the tire cage 50. The recording device assembly 426 is mounted on the lid 60 between, e.g., the two center beams 194 as shown in FIGS. 14 and 15. The image recording device assembly 428 is mounted to the inner support plate 62, wherein the cutout 430 (FIG. 16) is provided in this support plate for viewing the lower side of a tire 58. In some embodiments, a tread image recording device assembly 432 may also be provided as shown in FIGS. 14 and 15, wherein this assembly is substantially similar to the lower image recording assembly 428.

As can be seen from FIG. 15, the upper recording device 426 is appropriately offset from the center of the tire 58 so that an image of the seam between the tire rubber and split rim 157 can be captured.

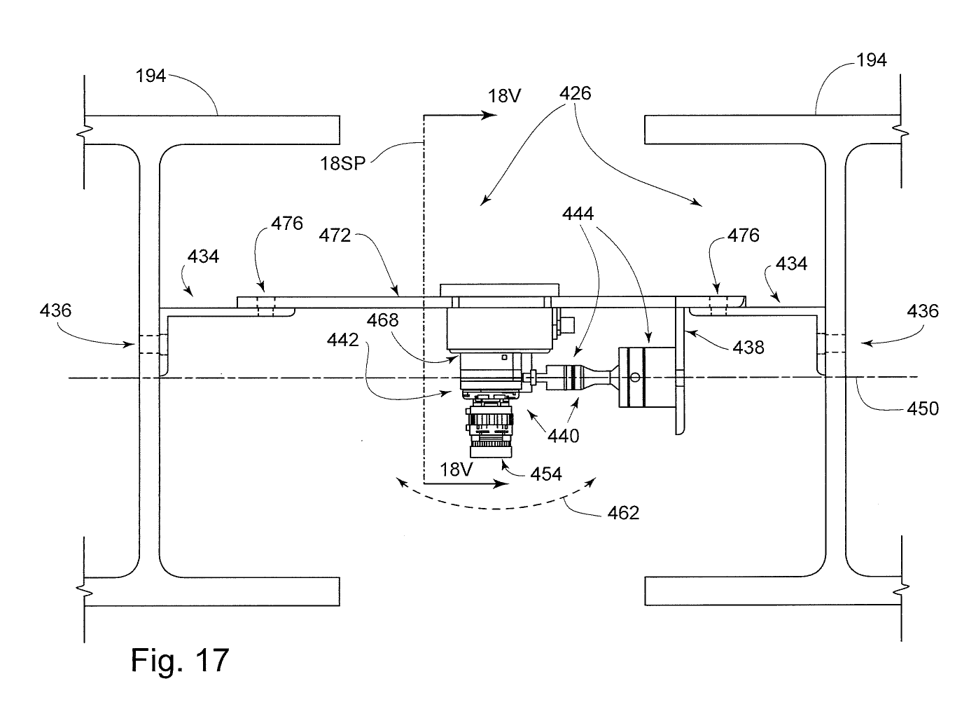

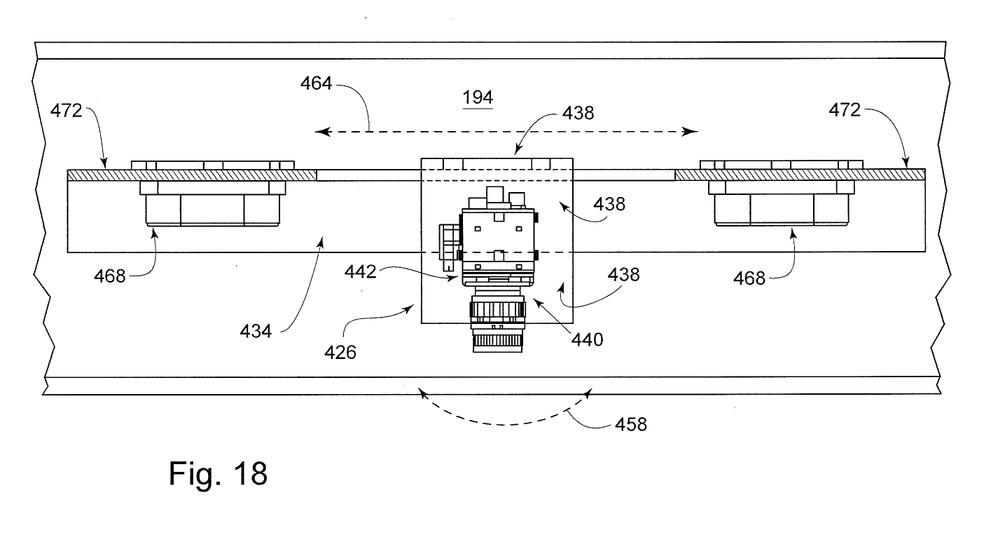

FIGS. 17 and 18 show more detailed views of the upper recording device assembly 426. The assembly 426 includes angle brackets 434 that are fixed to the adjacent beams 194, e.g., via bolts, rivets, screws or components having similar functionality that extend through a bore 436 in each of these adjacent beams (welding is also contemplated). Also included in the assembly 426 and attached to one of the angle brackets 434 is an “L” shaped plate 438 to which an image recording device subassembly 440 (of the assembly 426) is mounted. Each attachment (and all other attachments described hereinbelow unless otherwise specified) is similar to the attachment of angle brackets 434 to the adjacent beams 194, e.g., mating bore and insert fixture. The image recording device subassembly 440 includes a top imaging device 442 such as a camera, video recorder, or charged couple imager. In one embodiment, the top imaging device 442 is a Hitachi KP-D20B manufactured by Hitachi Corp, that produces color images. In particular, the KP-D20B has a ½-inch charge couple device (CCD) with a minimum sensitivity of 1.5 Lux. The KP-D20B also has an On-Screen-Menu system allowing for easy selection and adjustment of all camera parameters, such as video level, black level, chroma level, and enhancement, white balance, and shutter control. All parameters may also be controlled via an RS-232 interface for control via the operator station 422.

The top imaging device 442 is connected to a positioning subassembly 444 (of the assembly 426), wherein this positioning subassembly is in turn attached to the “L” shaped plate 438 (of the assembly 426) that is in turn secured to a corresponding one of the angle brackets 434. In one embodiment, the positioning subassembly 444 is an Automated Drive and Design (AD&D) 1BM25-20¼-20 articulating mount manufactured by Automated Drive and Design, LLC located at 6350 South Inwood Drive, Columbus, Ind. 47201, and this subassembly is able to rotate the top imaging device 442 about the axis 450 (FIG. 17) so that the lens 454 of the imaging device is able to rotate in the directions of arc 458 (FIG. 18) for viewing various portions of the tire 58 (including its split rim 157) according to electronic signals indicative of operator commands from the operator station 422. Note that in one embodiment, the top imaging device 442 can zoom in and zoom out on the tire 58 so that a portion of the tire can be magnified for viewing potential anomalies in the tire 58 (including its split rim 157). Note that the top imaging device 442 embodiment identified above can magnify up to 4 times; however, greater or lesser magnifications are also within the scope of the present disclosure. Moreover, the lens 454 may be a wide angle lens such as a Funjinon DF6HA-1B manufactured by Fujifilm Optical Devices U.S.A., Inc. However, alternative/additional embodiments of the top imaging device 442 and/or the image recording device subassembly 434 are within the scope of the present disclosure. For example, the positioning subassembly 442 may be able to also move the top imaging device 438 arcuately in the directions of arc 462 (FIG. 17). Moreover, in one embodiment, the “L” shaped plate 430 may be movable along a length of the angle brackets 424 (in the directions of double headed arrow 464, FIG. 18).

The upper video recording device assembly 426 also includes at least one and preferably a plurality of lights 468 for illuminating the tire 58. In one embodiment, these lights are Smart Vision S75-WHI Wide Lens Brick LED lights manufactured by Smart Vision Lights, 200 Viridian Drive, Muskegon, Mich. 49440. Each of the lights 468 may be fixedly mounted into a corresponding cross member 472 whose ends are attached to the angle brackets 434 via an attachment provided in the corresponding openings 476 formed from the alignment of the bores in the cross members 472 with those of the angle brackets 434 as indicated in FIG. 17. In one embodiment, the operator may control the intensity of light emitted from the lights 468.

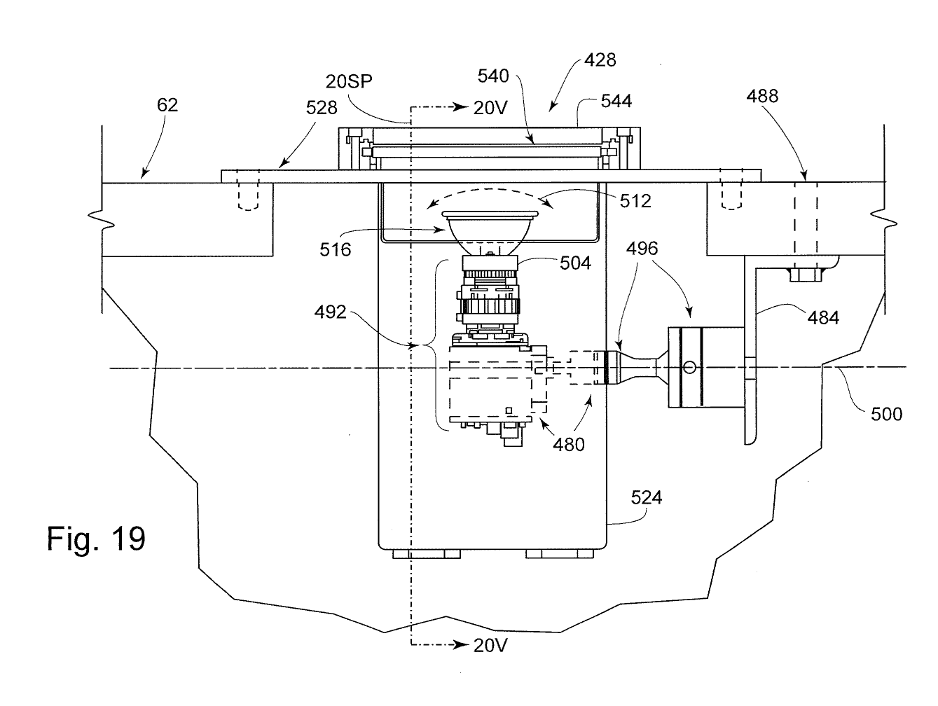

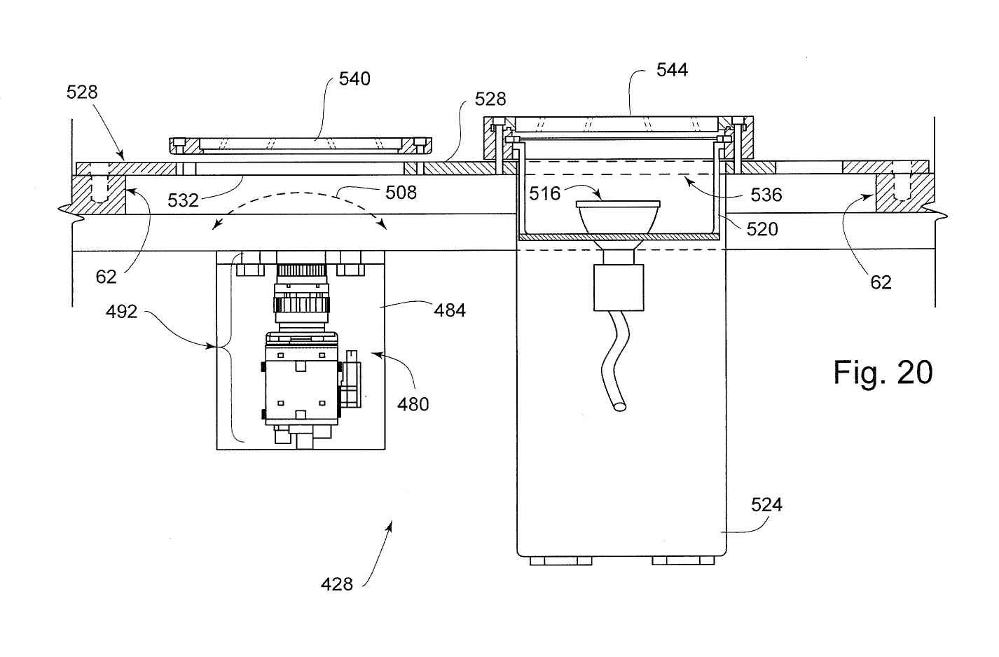

FIGS. 19 and 20 show more detailed views of the lower recording device assembly 428. The assembly 428 includes an image recording device subassembly 480 (FIG. 19) which is mounted on an angle bracket 484 that is, in turn, attached to the inner support plate 62, e.g., via bolts, rivets, screws or components having similar functionality that extend through a bore 488 in the inner support plate (welding is also contemplated). The image recording device subassembly 480 includes an imaging device 492 such as a camera, video recorder, or charged couple imager. In one embodiment, the imaging device 492 is a Hitachi KP-D20B manufactured by Hitachi Corp. that produces color images. The imaging device 492 is connected to a positioning subassembly 496 (of the assembly 428), wherein this positioning subassembly is, in turn, attached to the angle bracket 484. In one embodiment, the positioning subassembly 496 is an AD&D 1BM25-20¼-20 articulating mount, and is able to rotate the imaging device 492 about the axis 500 (FIG. 19) so that the lens 504 of the imaging device is able to rotate in the directions of arc 508 (FIG. 20) for viewing various portions of the tire 58 (including the lower side of its split rim 157) according to electronic control signals indicative of operator commands from the operator station 422. Note that in one embodiment, the imaging device 492 can zoom in and zoom out on the tire 58 so that, e.g., a portion of the tire can be magnified (as described hereinabove for the top imaging device 438) for viewing even small potential anomalies in the tire 58 (including its split rim 157). Moreover, the lens 504 may also be a wide angle lens such as a Funjinon DF6HA-1B. However, alternative/additional embodiments of the imaging device 492 and/or the image recording device subassembly 480 are within the scope of the present disclosure. For example, the positioning subassembly 496 may be able to also move the imaging device 492 arcuately in the directions of arc 512 (FIG. 19).

The lower video recording device assembly 428 also includes at least one light 516 for illuminating the lower side of the tire 58. In one embodiment, the light 516 is a halogen light. Each light 516 may be fixedly mounted in the bottom of an internally light reflective element 520 (FIG. 20) which may be, in turn, provided in the sealed interior of a canister 524 providing any necessary electrical transformers. The canister 524 may be positioned immediately below a covering plate 528 having openings 532 and 536 therein, respectively, for viewing the tire 58 by the imaging device 492, and for illuminating the tire via the light 516. In one embodiment, an operator may control the intensity of light emitted from each light 516. Additionally, in one embodiment, the canister 524 or a light 516 (e.g., without the canister) may be angularly adjustable for shining light on various portions of the tire 58. Such angular adjustments may be synchronized to move with a corresponding movement of the imaging device 492. In such an embodiment, such an angularly adjustable canister 524 or light 516 may be mounted to an additional positioning subassembly (not shown) that may be an identical copy of the positioning subassembly 496, and this additional positioning subassembly may be attached to, e.g., an extended portion of the angle bracket 484 so that the rotational axis 500 of the position subassembly 496 and a corresponding rotational axis for the additional positioning subassembly are parallel (and in fact, could be superimposed on one another in FIG. 19).

The lower video recording device assembly 428 also includes protective transparent members 540 and 544 for protecting, respectively, the imaging device 492 and the light 516 from dust, dirt and other debris that can fall off a tire 58 provided in the tire cage 50. Such transparent members 540 and 544 may be made of, e.g., glass or glycol modified polyethylene terphthalate. In one embodiment, a cleaning mechanism (not shown) may be provided for cleaning the upper surfaces of the transparent members 540 and 544 that face the tire 58. Such a cleaning mechanism may include one or more of an air blower and/or a wiper with a cleaning fluid dispenser for cleaning the upper surfaces of the transparent members 540 and 544 much like an automobile windshield wiper is able to clean an automobile windshield. Note that such a cleaning mechanism may be very desirable in that if such a transparent member ceases to have sufficient clarity due to, e.g., dust or dirt falling off a tire 58 within the tire cage 50, then a crane, hoist, and/or forklift may be required to remove the tire from the tire cage 50 just to clean the transparent members 540 and/or 544.

Referring now to the tread image recording device assembly 432, this assembly may be mounted on posts 545a having connecting cross members 545b. The assembly 432 may include a positioning subassembly 546 identical to the positioning subassembly 496, and also include an imaging device 547 identical to the imaging devices 442 and 492. Note that the tread image recording device assembly 432 may be vertically adjustable along the posts 445a so that this assembly can scan the entire tread of the tire 58 and/or be positioned appropriately for different sizes of tires 58. The tread image recording device assembly 432 may also include a light(s) 548 (FIGS. 15, 25) for illuminating the tire's tread. The light(s) 548 may be identical to the light 516. Note that in order to protect tread image recording device assembly 432 from tire debris in the event of a tire explosion in the tire cage 50, a shield 549 is provided between the assembly 432 and the tire 58. The shield 548 may be a steel plate that includes protective transparent members (not shown) for protecting, respectively, the imaging device 547 and the light 548 while at the same time allowing images of the tire's tread to be transmitted through the transparent members. Such transparent members may be similar to the transparent members 540 and 544 described hereinabove.

FIG. 14 further shows a routing of various flexible conduits 550 through the tire cage 50 for supplying power and operator commands from the station 422 to the upper and lower video device assemblies 426 and 428, and for receiving tire images at the display(s) 421 from each of the upper and lower video device assemblies.

Note that for the ease of the operator, controls at the operator station 422 may include one or more of (a) and (b) following:
(a) Controls for moving and/or positioning the imaging devices 442 and 492 as directed by the operator, e.g., in the directions of the respective arcs 458 (FIG. 18) and 508 (FIG. 20), wherein such movement may allow the operator to obtain a clearer view of a tire 58 in the tire cage 50 than may be available otherwise. Additionally, controls for such movement of the imaging devices 442 and 492 may include automatic reciprocating angular movement (“scanning rate” herein) in the directions of arcs 458 and 508 for scanning across the tire 58 (and its split rim 157) both top side and bottom side of the tire. Such automated scanning may be at a scanning rate that is related to the rate of rotation of the tire 58 within the tire cage 50, and/or related to the size of the tire in the tire cage 50. In particular, it is desirable for such a scanning rate of one or both of the imaging devices 442 and 492 to be such that all portions of the juncture between the tire-split rim 157 and the rest of the tire 58 being rotated on the pedestal 156 be clearly displayed on the display(s) 421 (and possibly archived in an electronic data repository). Note that such an automated control can free the operator from coordinating tire rotation speed with the angular scanning rate of the top imaging device 442.
   In one embodiment, there may be separate controls for independently positioning each of the imaging devices 442 and 492.
   Note that in some embodiments where the lights 468 and 516 are provided with synchronized corresponding movement with their imaging devices, control of each imaging device may also control the movement of the corresponding light(s) as well.
   Moreover, explicit operator positioning of one or both of the imaging devices 442 and 492 may stop any automatic rotation of the tire 58 by the pedestal 156.
   In one embodiment, the operator may position the imaging devices 442 and/or 492 via at least one joy stick (not shown), wherein, e.g., side to side movement of the joy stick moves the imaging devices 442 and 492 (possibly with their corresponding lights) synchronously in the radial direction across a tire 58 in the tire cage 50, and a movement of the joystick in forward direction (i.e., away from the operator) initiates or speeds up rotation of the tire 58 (e.g., to a maximum predetermined rotation rate), whereas pulling the joystick back (i.e., toward the operator first slows the tire rotation, then with additional backward joystick movement, stops the tire's rotation, and with even further backward movement, reverses the rotation of the tire).
(b) Controls for setting/resetting the imaging devices 442 and 492 to predetermined or default positions, focal lengths, and/or magnifications or views into the tire cage 50. Note that this predetermined or default view may be dependent on the size of the tire 58 mounted in the tire cage 50 since for different sizes of tires, the circular exposed juncture between the tire and its split rim 157 may be in different positions relative to the position of the imaging devices 442 and 492. In one embodiment, such predetermined or default settings for the top imaging device 442 may be additionally dependent on the height that the operator has positioned the tire 58 on the pedestal 156. Note that the controls for setting/resetting the imaging devices 442 and 492 may be provided by the joystick described in (i) immediately above.
   Further note that the controls described immediately above may also have graphical counterparts displayed on one or more of the display(s) 421 for assisting an operator.

### Energy Absorbing Block Replacement.

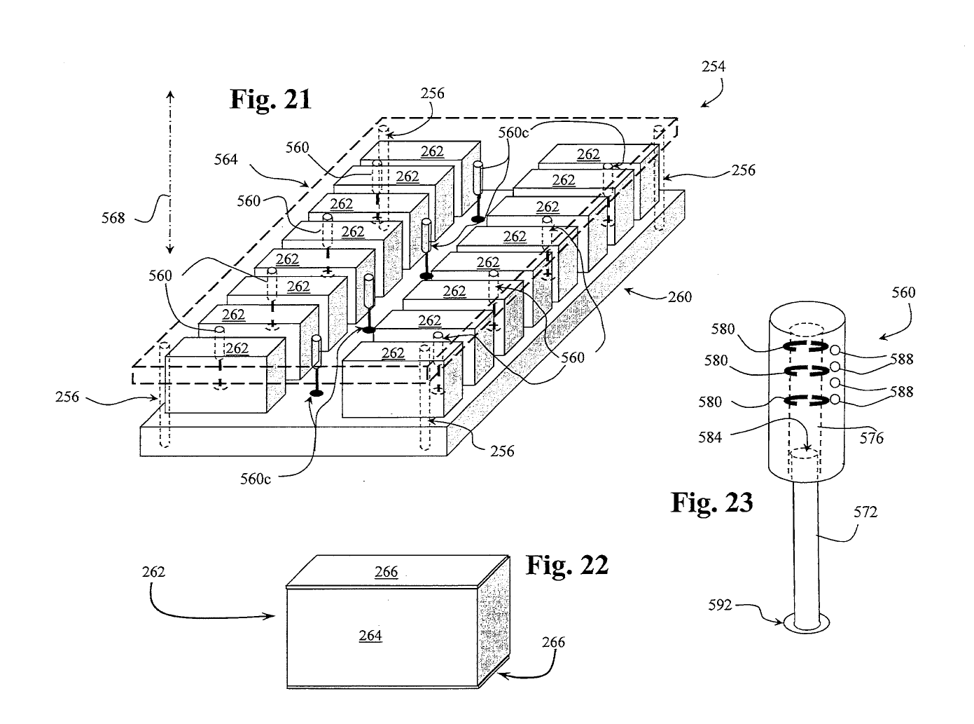

The energy absorbing subassemblies 262 (FIG. 22) can be expensive, and replacement thereof after a tire 58 explosion can also be labor intensive. Accordingly, various sensors may be provided for sensing the degree of compression of such energy absorbing subassemblies 262 (i.e., their included blocks 264) for thereby assessing whether various of the subassemblies 262 need to be replaced. FIG. 21 shows an embodiment one of the energy absorbing assemblies 254 (FIGS. 6, and 8), wherein there are a plurality of compression sensors 560 distributed between and/or about the subassemblies 262 for at least identifying which (if any) of their blocks 264 have compressed enough to require replacing and potentially also identifying at least a height compression of the blocks so that, e.g., the amount of additional kinetic energy that each such subassembly 262 can be relied upon to still absorb can be approximated. In one embodiment, there is a sensor 560 adjacent to each side of each subassembly 262, such that the sensor is close enough to a subassembly 262 side to reasonably measure the compression of the subassembly side (e.g., in one embodiment, the sensor is less than two inches from its adjacent corresponding subassembly side, and preferably less than one inch). Each sensor 560 is extends from the decoupler plate 260 (upon which the subassemblies 262 are positioned) to an upper plate 564 (outlined in a heavy dashed line style in FIG. 21). In particular, each sensor's height is at least the height of the subassemblies 262 which are also positioned between the decoupler plate 260 and the upper plate 564. Accordingly, when a tire 58 explodes within the tire cage 50, the sensors 560 provide one or more measurements related to the kinetic energy absorbed by the blocks 264 of the subassemblies 262. Such sensors 560 can be distributed in various arrangements between and/or about the subassemblies 262. FIG. 21 shows one such arrangement. In an alternative embodiment, only the middle row of four sensors 560c may be provided. In another embodiment, only the two outside rows, each having four sensors 560, may be provided. In another embodiment, only the corner sensors 560 nearest the anchors 256 may be provided. Of course, with a small number of the sensors 560 in comparison to the number of subassemblies 262, a sensor measurement may be attributed to more than one of the subassemblies 262.

The sensors 560 may measure the extent of compression of the subassemblies 262 in the direction of the axis 568. During a tire 58 explosion, a shaft 572 (FIG. 23) for each such sensor 560 may be forced into a recess 576 of the sensor resulting in the sensor outputting a measurement of how far the shaft 572 entered into the recess 576. In one embodiment, at least the tip 584 of the shaft 572 may be electrically conductive, and the recess 576 may snugly fit about the shaft, wherein for one or more positions along the length of the recess there may be one or more pairs 580 of annular electrical contacts lining the recess so that when the shaft 572 contacts any one of the pairs 580, the shaft (i.e., a conductive portion thereof such as the tip 584 thereof) allows an electrical signal to be transmitted between the electrical contacts of the pair wherein the signal is then transmitted to the computer 424 (FIG. 14, or more precisely, to the energy absorbing material manager 628 of FIG. 25 described hereinbelow) so that a graphical display of the energy absorbing assemblies 254 may be shown on one of the displays 421 with information indicative of the extent of compression measured by each of the sensors 560. In one embodiment, for a subassembly 262 whose nearest one or more sensors 560 each have a compression measurement of less than a first predetermined amount (e.g., 50% of the height of the subassembly's original non-compressed height), such a subassembly may not be replaced. Conversely, for a subassembly 262 whose nearest one or more sensors 560 each have a compression measurement of greater than or equal to the first predetermined amount, such a subassembly may be replaced. For each subassembly 262 having at least one nearby sensor 560 (e.g., within 2 inches, and preferably within 1 inch) with a measurement of less than the first predetermined amount and another nearby sensor with a measurement greater than or equal to the first predetermined amount, an average of the compression measurements from the one or more nearest sensors may be used to determine the degree of compression of the subassembly 262 and whether to replace the subassembly. However, in another embodiment, such a subassembly 262 may be identified for replacement.

In FIG. 21, for each subassembly 262, its associated nearest sensors 560 include the nearest sensor 560c in the middle row of sensors, and the nearest sensor of the other sensors 560 not in the middle row. Assuming subassembly 262 replacement according an average compression of adjacent sensors 560, if such an average compression for a given subassembly 262 is greater than the first predetermined amount, then the subassembly may be replaced. However, even if the average is less than the first predetermined amount, but one of the nearest sensors 560 measures a compression of above a second compression predetermined amount that is greater than the first predetermined amount (e.g., the second compression predetermined amount may be 65% of the height of the subassembly's original non-compressed height), then the subassembly may be identified for replacement. Note that the processing (e.g., execution of software) to perform the above described determination of which of the subassemblies 262 to replace (after a tire 58 explosion) may be executed on the computer 424, wherein a graphical presentation can result on one of the displays 421 showing each of the energy absorbing assemblies 254 and identifying the one or more subassemblies 262 that should be replaced. Additionally, the software (also denoted “block analysis software” herein) may also identify other subassemblies 262 for operator inspection and possible replacement. For example, the block analysis software may identify one or more subassemblies 262 for operator inspection when there is substantial variation in compression measurements (e.g., one nearby sensor 560 measuring a 20% compression, and another nearby sensor measuring 65% compression). Moreover, the identification of such a subassembly 262 may be provided to the operator even though the average compression of the nearest sensors 560 associated with the subassembly (i.e., the sensors from which a compression of the subassembly is computed) is below the first predetermined amount. In particular, such a subassembly 262 may be graphically identified on a display 421, e.g., via highlighting, blinking, etc. together with its position within the energy absorbing assembly 254 containing the subassembly.

Note that in one embodiment, each of the subassemblies 262 may include one or more sensors 560. For example, each corner edge between sides of a subassembly 262 may have one of the sensors 560 aligned lengthwise therewith such that this sensor is, e.g., within an inch or less of the corner edge. In particular, such a sensor 560 may reside within a bore extending between the metal plates 266, or may reside external to the block 264 but integral with the subassembly 262 therefor. Alternative embodiments may include different configurations of sensors 560 integral with subassemblies 262, e.g., such a sensor 560 may reside within a bore extending between the metal plates 266, wherein the bore goes through (or near) a center of mass of the block 264.

The block analysis software may also compute an aging measurement for the subassemblies 262 when such assemblies have experienced one or more tire 50 explosions so that regardless of the amount of compression, such subassemblies may be identified for inspection more often and/or identified for replacement after a certain length of time or tire explosions. Regarding such aging of subassemblies 262, with each compression of a subassembly 262 there may be cracks in the outer coating of non-corrosive material (e.g., gold) of the subassembly and such cracks may (e.g., over time) compromise the energy absorbing effectiveness of the block 264 therein. Additionally, the internal open rigid cell structure of the blocks 264 may be compromised more than is evident by measuring height compression if ambient air, moisture or corrosive vapors enter the rigid open cells 408 (FIG. 12) of the blocks 264. Thus, the aging of a subassembly 262 may be dependent upon the number tire explosions the subassembly has experienced wherein there has been any non-trivial compression (e.g., more than approximately 3% to 5% of its original height) as well as a length of time the subassembly 262 has been in service, e.g., since the first tire explosion it has experienced, or the first non-trivial compression it has experienced.

In one embodiment, if the aging of a subassembly 262 commences from an initial non-trivial compression, with each additional tire 58 explosion to which the subassembly is subjected, the aging of the subassembly may be accelerated (e.g., an aging rate may be doubled). Also, such an aging rate may also be accelerated when the compression of the subassembly is determined to be greater than, e.g., 20%, and even greater when the compression of the subassembly is determined to be greater than 35%. Accordingly, when the age measurement of a subassembly 262 reaches a predetermined value, the subassembly may be either replaced, or at least closely inspected for replacement. In one embodiment, after each tire explosion within the cage 50, each of the subassemblies 262 may be inspected for obvious cracks to the non-corrosive coating, and identifications of the subassemblies having such cracks may be input by the operator to the block analysis software so that such cracked subassemblies can have their aging accelerated. In one embodiment, the block analysis software assumes each of the subassemblies 262 commences aging from the time it is positioned within a tire cage 50, and there may be a maximum lifetime for each such subassembly of, e.g., 10 years to reside in a tire cage 50.

In one embodiment, a tire cage operator may be required to disassemble one or more energy absorbing assemblies 254 to examine each subassembly 262 for cracks as well as provide an additional coating of a non-corrosive material on the subassembly. For example, for certain copper alloy metal foams such an additional coating may be a paint or epoxy for forming at least an additional water barrier. However, in one embodiment, each subassembly 262 may be vacuum sealed in, e.g., a plastic bag, wherein after each tire explosion experienced, each of the subassemblies are removed from their bags and vacuumed sealed in new bags. Note that the aging rate and/or the age of a subassembly 262 may only be increased in this later embodiment if the operator determines that the vacuum seal on the subassembly is broken and enters such information into the computer 424.

In one embodiment, the aging of the subassemblies 262 may be determined by one or more computational models of the subassemblies. One such model may be based on multivariate statistical model based on the parameters of time in service, the number of tire explosions experienced, the degree of explosion compression, etc. Additionally/alternatively, such a model may be based on a learning computational paradigm such as an artificial neural network, vector machine, etc.

Since there may be multiple layers of assemblies 254 that are layered between a tire 58 and the frame of the tire cage 50 (in particular, the beams 194), wherein, e.g., the upper plate 564 of one of the assemblies 254 also functions as the decoupling plate 260 of a next layer, the sensors 560 for each one of the layered assemblies 254 may be used to determine whether there has been any detectable or appreciable compression of each layer (i.e., the subassemblies 262 therein). Thus, if the sensors 560 of a particular layer have not detected at least a threshold amount of compression (e.g., such threshold may be less than 0.5% of the layer's original spacing between its decoupling plate 260 and its upper plate 564, it may be unnecessary for the operator to disassembly such a layer after a tire explosion within the tire cage 50. Thus, in one embodiment, the use of multiple layers of assemblies 254 of, e.g., subassemblies 262 having a reduced height may reduce operator work where there is a reduced amount of tire explosion kinetic energy to be absorbed such as would occur when smaller tires 58 are serviced within the tire cage 50.

As shown in FIG. 23, such sensors 560 may include a plurality of LEDs 588, e.g., one green and one red, wherein for sensors that have not been compressed beyond the first predetermined amount (e.g., the tip 584 has not contacted the lowest pair 580 of electrical contacts), the green LED 588 remains lighted, and once a sensor 560 has been compressed beyond the first predetermined amount the red LED 588 lights and the green LED 588 turns off. Thus, in one embodiment, subassemblies 262 whose nearest sensor 560 has its red LED 588 lighted will be replaced. In another embodiment, each sensor 560 may have three LEDs 588, e.g., one green, one yellow, and one red, wherein:
(i) For sensors that have not been compressed beyond an initial predetermined amount (e.g., 30% of the height of the subassembly's original non-compressed height), their green LEDs 588 remain lighted (e.g., the tip 584 has not contacted the lowest pair 580 of electrical contacts);
(ii) Once a sensor 560 has been compressed beyond the first predetermined amount, but not beyond an additional predetermined amount (e.g., 40% of the height of the subassembly's original non-compressed height), the yellow LED 588 lights (e.g., the tip 584 has contacted the lowest pair 580 of electrical contacts, but has not contacted next lower pair 580 of electrical contacts) and the green LED 588 turns off; and
(iii) When a sensor has been compressed beyond the first predetermined amount as described above (e.g., 50% of the height of the subassembly's original non-compressed height), the red LED 588 lights and both the green and yellow LEDs 588 are switched off (e.g., the tip 584 has contacted the second from the lowest pair 580 of electrical contacts). Thus, as described above, any subassembly 262 having a nearest sensor with a red LED 588 lighted may be replaced.

An additional one or more LEDs 588 may be provided for, e.g., signaling that compression above the second predetermined amount has occurred. However, such identification may only be shown on one of the displays 421.

The sensors 560 may measure additional levels of compression such as by the upper most pair 580 of electrical contacts (FIG. 23), wherein a compression to this extent is indicative of adjacent subassemblies 262 transmitting tire explosion kinetic energy rather than absorbing such kinetic energy (e.g., above 75% of the height of the subassembly's original non-compressed height, or where the block 264 therein enters its the densification zone beyond its crush plateau). In particular, a subassembly 262 nearest a sensor 560 that is compressed such that the upper most pair 580 of electrical contacts are electrically activated may be an indication for operator examination of the tire cage 50 itself to determine if it has sustained damage in a tire explosion since there is the possibility that a large amount of explosive energy has been transmitted to the tire cage itself. Additionally, a sensor 560 compression measurement beyond the upper most pair 580 of electrical contacts may indicate that one or more of the subassemblies 262 are not as effective in absorbing explosive energy as expected (e.g., due to one or more of: a miss rating of the subassembly's energy absorbing capability, the subassembly being defective, the subassembly having a different composition from what the tire cage 50 was designed to use, e.g., a different type of metallic foam, and/or an inadequate aging of the subassembly). Note that for a sensor 560 capable of measuring such extreme compressions, an additional LED 588 may be provided on the sensor, wherein, e.g., this additional LED 588 may be, e.g., purple when lighted. Thus, when such extreme compressions are detected by a sensor 560, both the red LED identifying that the nearby blocks 264 need replaced, and the additional purple LED indicating that an exceptional amount of explosive energy was detected remain lighted.

Since the block analysis software on the computer 424 (or data storage accessible by the software) may retain historical information regarding past compressions of each of the subassemblies 262, if after a tire explosion, one or more of the sensors 560 goes from a green lighted LED 588 to, e.g., a purple lighted LED, this event may be an indication that the nearby subassemblies 262 are not effectively absorbing tire explosion kinetic energy. In such a circumstance, the manufacturer or supplier of such subassemblies 262 may be contacted.

Note, in one embodiment, the computer 424 maybe connected to a network (e.g., the Internet) so that information regarding a tire explosion within the tire cage 50 may be recorded at a central network site (e.g., a website) that monitors such tire cages 50. In particular, such a central network site may be notified if any sensor 560 that detects an extreme compression, e.g., indicative of a subassembly's compression beyond, e.g., 75% of the height of the subassembly's original non-compressed height, or where the block 264 therein enters it's the densification zone beyond its crush plateau.

Note that the sensors 560 may each include a biasing component(s) for biasing each shaft 572 to extend out of its corresponding recess 576 so that each sensor extends between and contacts each of the corresponding decoupler plate 260 and the corresponding upper plate 564 between which the sensor is positioned. The biasing component(s) (not shown in FIG. 23) may be a spring, an elastomeric material, or other resilient mechanism for biasing the shaft 572 to protrude out of its recess 576. Additionally, the recess 576 may include a stop or other mechanism for preventing the shaft 572 from entirely disengaging from the recess.

Each sensor 560 (or operator selected sensors) may be reset, e.g., from operator input to the computer 424 so that such a sensor(s) is (re)calibrated to output a reading indicative of no compression even though the sensor may be compressed, e.g., from replacement of all subassemblies 262 with alternative subassemblies having a reduced height. Other operator resets may occur when there is some computer 424 input indicating that specifically identified subassemblies 262 are replaced. Such an indication may be from receiving an operator input to the computer 424 indicating that certain identified blocks 264 have been replaced. Note that, at least in one embodiment, a value indicative of a sensor 560 being fully extended (e.g., of the shaft 572 extending out of its corresponding recess 576) is insufficient for determining whether to reset the sensor's measured extension. For example, if a sensor 560, S, is included in two distinct collections of sensors, each collection used in measuring the compression of a different subassembly 262, then if one of the subassemblies is replaced but the other is not (e.g., due to a lesser compression from a tire explosion), then sensor S data associated with the replaced subassembly 262 should be recalibrated or reset to indicate no compression, whereas sensor S data for the compressed but not replaced subassembly should not be recalibrated or reset. Accordingly, for each sensor 560, distinct sensor compression data may be retained for each subassembly 262 whose compression is measured by the sensor.

The various numbers of sensors 560 may be positioned in or about the subassemblies 262, and the sensors can be configured in various configurations depending on, e.g., the configuration of the subassemblies 262 used (see the Appendix herein for alternative subassembly configurations). Each sensor 560 may have a magnetic base 592 for positioning and maintaining it upright on its decoupling plate 260.

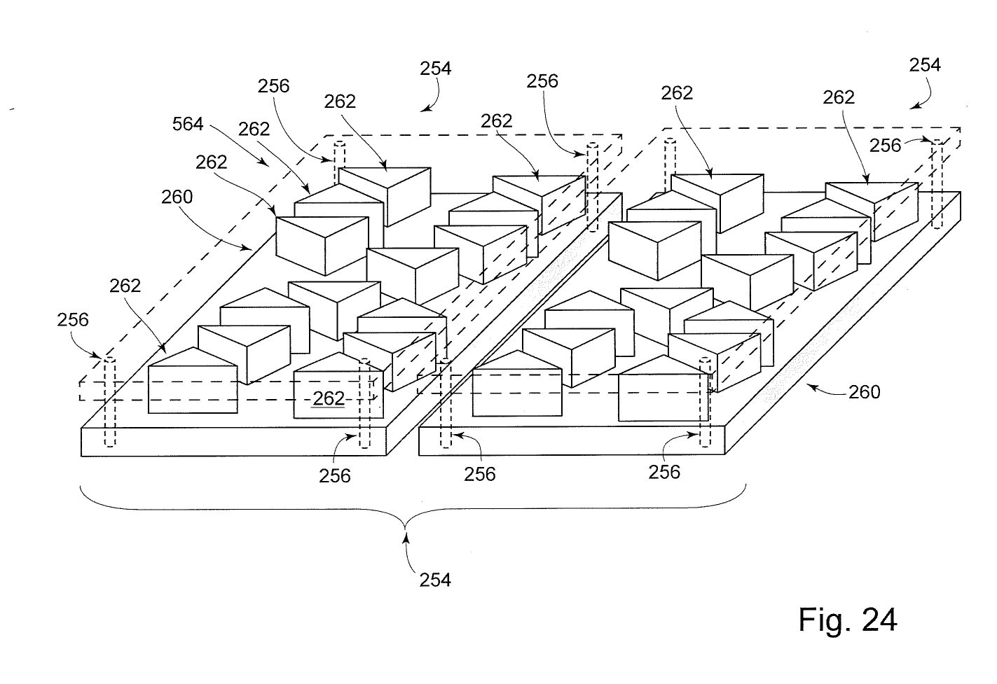

Additionally, it is within the scope of the present disclosure that the subassemblies 262 need not be in the shape of blocks. Such subassemblies 262 may be cylindrical (not shown), have a triangular top surface (as shown in FIG. 24), or have a hexagonal top surface (not shown).

Note that upon replacing some of the subassemblies 262 (but not all), there may be a difference in height and/or angular orientation of the tops of the subassemblies facing the upper plate 564. Accordingly, the operator may be required to attach various (metal, e.g., steel or aluminum) shims to the top and/or the bottom surface of the non-replaced subassemblies 262 that have been somewhat compressed in one or more tire explosions within the tire cage 50, wherein each such shim is attached to its corresponding subassembly 262 via any suitable method, e.g., a metal shim attachment (not shown) that includes a recess for fitting on top of the block, wherein, e.g., a shim slidably locks into the shim attachment.

Regarding such a shim attachment, it may have side portions that extend some ways down the sides of a subassembly 262 (to which it is attached) for stabilizing the shim attachment on its subassembly. However, such side portions do not significantly impact airflow from the subassembly (in the event that the subassembly is not vacuumed sealed) when compressed during a tire explosion. For example, each of the side portions of such a shim attachment may extend over a corresponding subassembly 262 side approximately 25% of the original height of the subassembly. Each side portion may include an “L” shaped corner extension that covers and mates with a corner of its subassembly 262 such that only a small amount of each of the adjacent sides of the subassembly 262 corner is covered, e.g., approximately ½ inch of subassembly coverage along the subassembly side.

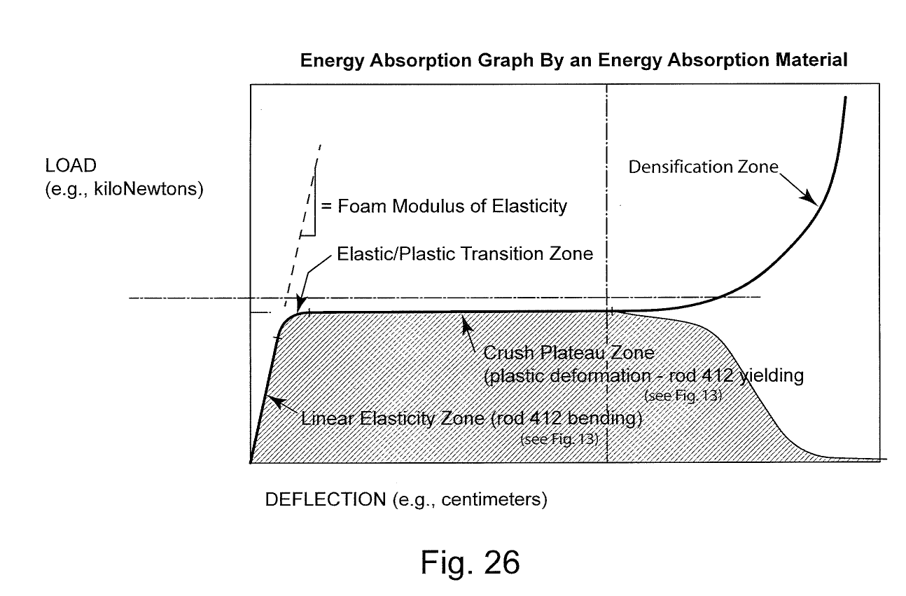

Further note that for sensors 560 adjacent to such a non-replaced subassembly 262 (i.e., the sensors used to measure the compression of the non-replaced subassembly), the computer 424 (more particularly, the energy absorbing material and sensor database 623 of FIG. 25 described hereinbelow) retains a record of the total compression of this subassembly so that, e.g., if after a first tire explosion, the non-replaced subassembly is determined to have been compressed approximately 25% of its original height, and after a second tire explosion, this same non-replaced subassembly is determined to have compressed another 10% of its original height, then the computer 424 (and/or the energy absorbing material and sensor database 623 of FIG. 25 described hereinbelow) retains a total compression of 35% of the non-placed subassembly. Accordingly, if in yet a third tire explosion in the tire cage 50, it is determined from sensor 560 readings that this same subassembly has been compressed an additional amount, and if the total amount of subassembly compression (with this additional amount) is determined by the block analysis software to be greater than the first predetermined amount, then this subassembly will be identified for replacement both on one of the displays 421, and by the LEDs on one or more of the sensors 560 in or adjacent to the subassembly. Accordingly, the LEDs 588 can be under computer 424 control so that, e.g., even though a sensor 560 is extended due to the placement of shims thereabouts, the LEDs may still light according to a compression of an adjacent one of the subassemblies 262. Note that a compression measurement of a subassembly 262 may be determined by computing the remaining volume of the subassembly 262 instead of computing a measurement indicative of a height of the subassembly. Moreover, the correspondence between such a compression measurement of a subassembly 262 and an estimate of the remaining energy that can be absorbed by the subassembly is dependent upon a graph such as shown in FIG. 26. In particular, the energy absorbing capacity of a non-compressed subassembly 262 is represented by the cross hatched portion in FIG. 26, wherein the cross hatched portion to the right of the vertical dash-dot line 593 is generally excluded in determining such energy absorbing capacity since this portion is held in reserve so that if the explosive energy is, e.g., 50% to 100% greater than expected, there will not be catastrophically failure that could, e.g., destroy or severely damage the tire cage 50. Accordingly, the cross hatched portion to the left of vertical dash-dot line 593 represents the energy absorbing capacity for use in determining the useful energy absorbing capacity of a subassembly 262 as a function of the deflection (e.g., compression of the height of the subassembly 262). Thus, if such a subassembly 262 experiences a tire explosion and is compressed an amount corresponding to the vertical dash-dot line 594, then the useful remaining energy absorbing capacity of a subassembly 262 is represented by the cross hatched portion between the vertical dash-dot lines 593 and 594.

The sensors 560 and the subassemblies 262 can be accessed for rearrangement, replacement, and/or resetting by manipulating or reconfiguring the anchors 256 so that the space between the decoupling plate 260 and the upper plate 564 is increased sufficiently to allow an operator to access the sensors 560 and the subassemblies 262. In one embodiment, each of the anchors 256 may be secured at one end to the decoupling plate 260 nearest to a tire 58 positioned on the table 164 (FIG. 11), and an opposite end of the anchor is slidably retained in a cylindrical steel tube (attached to the lid 60) wherein the tube 595 (FIG. 8) extends only part way from bottom of the impact beams 194 (when the lid 60 is in the closed position) to the decoupling plate 260. In particular, the anchor 256 may be slidable along the center cylinder axis of its corresponding tube 595, and the tube may extend only far enough between the impact beams 194 and the decoupling plate 260 to maintain the vertical orientation of the anchor 256 during a tire explosion but not far enough that movement of the decoupling plate during a tire explosion would typically contact the tube. Alternatively, the tube 595 may extend to the decoupling plate 260 if the tube is sectioned in a telescoping fashion so that during a tire explosion the tube can reduce its vertical extent (by telescoping within itself) without it being damaged.

For retaining and securing each anchor 256 within its corresponding tube 594, there may be, e.g., a corresponding retaining component 596 (FIG. 8) to prevent the anchor from sliding out of the tube. In particular, assuming the upper most end of each anchor 256 (when the lid 60 is closed) extends between the impact beams 194, each retaining component 596 may be, e.g., a large wing nut threaded onto this end of the anchor. Accordingly, when the lid 60 is in its closed position and operable for containing a tire explosion, each tube 595 and its corresponding anchor 256 is vertical, and its retaining component 596 functions to tightly sandwich the subassemblies 262 within their energy absorbing assemblies 254. Thus, during a tire explosion within the tire cage 50, instead of the anchors 256 bending or breaking, the anchors slide upwardly within their respective tubes 594 as the decoupling plate 260 nearest the exploding tire moves upwardly. Moreover, if there are a plurality of layers energy absorbing assemblies 254, the decoupling plate(s) 256 and the upper plates 564 for such additional assemblies 254 may have, for each anchor 256, a bore therethrough so that their corresponding layers slide on the tubes 594 and/or their anchors during a tire explosion.

Each sensor 560 may have a magnetic base 592 for positioning and maintaining it upright on its decoupling plate 260.

Referring to FIG. 25, this figure shows one embodiment of the components of the tire cage 50 that are in communication with an embodiment of a computational controller 620 installed on the computer 424 or having one or more of its components remotely residing on computational equipment wherein communication with other components and/or the tire cage 50 may be via the Internet. In one embodiment, the controller 620 substantially controls the operation and configuration of the tire cage 50 in cooperation with communication from an operator who: (i) provides input to the controller 620 via the operator interface 621 which receives input from, e.g., operator input devices as described hereinabove, and (ii) receives outputs from the controller 620 via this operator interface. Note that the operator interface 621 may include hardware/software drivers for the monitor(s) 420 (which may include a touch screen as an operator input device) as well as drivers for operator input devices such as a joy stick, a mouse and/or a trackball or other hand control.

Prior to describing additional components shown in FIG. 25, it is worthwhile to distinguish in the description following between a tire 58 (which includes its rim), the tire rim, and tire casing (which is the tire 58 portion not including its rim). Accordingly, unless otherwise stated throughout the present disclosure, the unmodified term “tire” (e.g., tire 58) refers to the tire casing and tire rim operably combined.

The controller 620 has associated therewith a tire attribute database 622 having information about tires 58, e.g., that have been inspected, inflated or deflated using the tire cage 50. For each tire having information in the tire attribute database 622, such information may include at least:
(622.a) A unique identifier for the tire 58 so that stored data related to the tire can be accessed according to its unique identifier, and
(622.b) A manufacturer/supplier tire identification data (e.g., a model/serial number, tire size data, and tire type).

Note that (622.a) and (622.b) immediately above may be input, via the operator interface 621, by a tire operator. Additionally, after at least one tire inspection, deflation, or inflation within the tire cage 50 of a tire 58, the tire attribute database 622 will preferably include the following data items (for one or more of the tire with its rim, and the tire casing):
(622.c) For each tire 58 inspection (e.g., in the tire cage 50), data indicative of:
   (i) A length of time the tire (with its rim), and/or the tire casing has been in service.
   (ii) Data indicative of a general condition of the tire and/or tire casing determined at the time of inspection, e.g., the data may include information indicative of one of: the tire casing is near to replacement, or near new, or worn but safe for continued use, etc.
   (iii) The mileage on the tire and/or tire casing.
   (iv) Whether the tire and/or tire casing shows signs of substantial use while underinflated or overinflated.
   (v) Linking data for accessing a video of substantially an entire scan of the tire, including its split rim, such scans residing in the tire image database 624 described hereinbelow.
   (vi) Linking data for accessing a picture(s) or videos (residing in the tire image database 624 described hereinbelow) of each portion of the tire that was been identified for monitoring, together with a description for locating the tire portion to be monitored. For example, each such picture or video may have an encoding therewith for identifying where on the tire 58 the imaged tire portion is located. Such an encoding may be, e.g., an angular tire rotation offset from, e.g., the tire's valve stem together with a radial offset from the center of the tire; thus, e.g., an encoding of 45° and 166 cm would be a positive angular offset of 45° from the tire's valve stem and 166 cm radial distance from the tire's center. Such tire portions may be:
      (1) For the tire casing: tire gashes, tire cuts, tire cracks, tire chunks missing, tire deformations such as bulges, bubbles, etc.
      (2) For the tire's rim: split rim deformations, any detectable functional/structural rim defect or functional/structural defect in a split rim component (e.g., a locking ring, a split-spring flange, a separable disc or hub, a rim or separable portion thereof, a beadlock, a beadlock insert, etc.). Note that such functional/structural defects may include, e.g., a metal crack, an inappropriate bend or wobble, a deep gash, a weakened area (e.g., due to rusting, a broken weld, a poor quality previous repair, etc.), a missing component (e.g., a missing locknut), etc.
      (3) For the juncture between the rim and the tire casing: improper seating on the rim, inappropriate tire casing wear/slippage with the rim, etc.
   (vii) Linking data for accessing a previous (if any) tire inspection(s) of the tire.
(622.d) A contact person(s) to be contacted, e.g., in the event the tire 58 requires replacing or explodes.
(622.e) For the tire rim, a unique identification number, a manufacturer or supplier, the type of rim, description and/or pictures or videos of rim portions that are being monitored (if any). Note, in one embodiment, it is assumed that substantially any functional/structural rim defect or functional/structural defect in a split rim component that is detected will be immediately repaired/replaced, or the rim will be taken out of service.
(622.f) Tire default scanning attributes, including: a default tire rotation rate on the table 159 (the longer a tire has been in service, and the more tire portions to monitor, then the slower the default tire rotation may be for scanning the tire and presenting the scan to an operator), table 159 height setting, imaging devices 438, 492 and 547 position settings, and/or lights 468, 516 and/or 548 position settings (if applicable).

The controller 620 also has associated therewith an energy absorbing material and sensor database 623 having information about the energy absorbing assemblies 254, and more specifically, energy absorbing subassemblies 262 thereof. In particular, various data items have been described hereinabove to be retained for subsequent access in configuring and/or replacing the energy absorbing subassemblies 262 and/or sensors 560. The following data may be electronically stored in the energy absorbing material database 623:
(623.a) For each energy absorbing assembly 254, the following data items may be stored:
   (i) Data indicative of a size and/or shape of the energy absorbing assembly 254; e.g., a length, width, and thickness or depth. Note that embodiments of the energy absorbing assemblies 254 may be contoured to facilitate protecting additional portions of the interior of the tire cage 50 such as actuator 204 (FIG. 7) for front plate 202. In particular, a decoupling plate 260 and any corresponding plate 564 (having energy absorbing subassemblies 262 therebetween) may be shaped to generally conform to, e.g., a corner (protruding or receding), a projection such as a box, a recessed volume, and/or a smoothly curved surface;
   (ii) Data indicative of a location within the tire cage 50 of the energy absorbing assembly 254. Such location indicating data may include: (1) coordinates relative a predetermined location (e.g., interior to the tire cage 50 of an exterior corner of an assemble 254), (2) an orientation of the assembly 254 relative, e.g., to some portion of the interior of the tire cage 50, or an angular offset from the horizontal or vertical. Note that in one embodiment, such assemblies 254 may be placed between a tire 58 in the tire cage 50 and componentry and/or members of one or more sides of the tire cage to thereby protect such componentry and/or members;
   (iii) A maximum estimated energy/force the assembly 254 is able to currently absorb (which may reduced after one or more previous tire explosions); and
   (iv) A maximum in service time without inspection/replacement.
(623.b) For each the energy absorbing subassembly 262, the following data items may be stored:
   (i) Identification data for uniquely identifying the subassembly 262;
   (ii) A current location of the subassembly 262 within its energy absorbing assembly 254;
   (iii) A measurement indicative of the compression (if any) the subassembly 262 has sustained in a previous tire 50 explosion(s);
   (iv) An estimate of the energy/force that the subassembly 262 can still effectively absorb without entering it's the densification zone beyond its crush plateau;
   (v) An age of the subassembly 262 as described hereinabove;
   (vi) Data identifying the sensors 560 associated with the assembly 262 for computing a new compression measurement and age, e.g., after a tire explosion; and/or
   (vii) A maximum in service time without inspection/replacement.
(623.c) For the sensors 560, the following data items may be stored:
   (i) For each sensor 560, a sensor identification data for uniquely identifying the sensor, the degree of compression (if any) it has sustained in previous tire 50 explosions (if any), a current location of the sensor within its energy absorbing assembly 254;
   (ii) A list of identifications of one or more of the subassemblies 262 for which compression measurements from the sensor are used in determining a compression and age of these subassemblies 262; and/or
   (iii) A maximum in service time without inspection/replacement.

The controller 620 also has associated therewith a tire image database 624 having image scans, pictures and/or videos of tires 58 inspected within the tire cage 50. A description of the image data provided in the tire image database 624 is described above in the description of tire 58 histories stored in the tire attribute database 622, and more particularly, in items (622.c)(v) and (622.c)(vi) of the description. In addition, for each tire 58, its scan(s), picture(s), video(s), and any other image data has associated therewith, the unique identification of the tire 58 to which such tire image data pertains.

Referring to the components of the controller 620, it includes an energy absorbing material manager 628 which:
(628.a) Receives information for identifying each active sensor 560 of each of the energy absorbing assemblies 254, and the position of each active sensor relative to the subassemblies 262 of the assembly 254. Note, sensor 560 position information as well as subassembly 262 position information can be input by a tire cage 50 operator in one embodiment;
(628.b) Receives sensor 560 compression information in the event of a tire 58 explosion;
(628.c) Outputs to the display(s) 421a graphical display of the energy absorbing assemblies 254 with information indicative of the extent of compression measured by each of the sensors 560 associated with each of the subassemblies 262 of each of the assemblies 254; and
(628.d) Determines the aging and replacement of the subassemblies 262 as described hereinabove, e.g., via the block analysis software and the computational models of the subassemblies 262 also described hereinabove.
   The controller 620 also includes a tire pedestal controller 632 which:
(632.a) Controls the raising and lowering of the tire table 159 via actuator 634 (FIG. 25); and
(632.b) Controls the rotation of the table 159 via signals to the motor 167 (FIGS. 10A, 10B).
   The pedestal controller 632 may operate according to tire operator input, and according to input from the tire scanning & imaging module 654 described hereinbelow. The pedestal controller 632 may be activated to lower/raise (if necessary) the table 159 to a predetermined position prior to or during the closing of the lid 60 so that the lid will fully close and lock (with a tire 58 on the table). Such a predetermined position may be determined by the pedestal controller 632 based on the size of the tire 58 in the tire cage 50, such that the size of the tire may be input to the controller 620 by a tire cage operator, or the tire size may be retrieved from the tire attribute database 622 using an operator input of the tire's unique identification data.
   Note, there may be sensors 635 (e.g., optical beam sensors) that detect obstructions, e.g., in the path of a tire 58 being raised or lowered on the table 159, in the opening or closing of the lid 60, and/or in the opening or closing of the front plate 202, etc.

The controller 620 also includes an emergency stop manager 636 which may perform the following tasks:
(636.a) When activated by a tire operator, or due to an automatic activation by the controller 620; such automatic activations may be due to, e.g., tire cage 50 sensors detecting an inappropriate or unsafe condition, such sensors being, e.g.: the sensors 635, and/or 560 described above, and/or sensors 640 for detecting an obstruction or an increase in resistance to: (i) the opening or closure of the front plate 202, (ii) the opening or closing of the lid 60; and/or (iii) the raising or lowering of the table 159. In one embodiment, activation of the emergency stop manager 636 may result in the tire cage 50 being configured in a predetermined condition that depends on the configuration when an emergency is detected. As examples, if tire cage emergency is detected while closing the lid 60, then the lid 60 may be caused to move in an opposite direction to a half open, half closed position. If tire cage emergency is detected while a tire 58 is being inflated, then inflation is stopped but the tire cage lid 60 will remain closed and locked. If an emergency is detected while the table 159 is being adjusted, then the adjustment of the table may be first stopped, and subsequently the table may be readjusted to a predetermined position; and
(636.b) When activated, the emergency stop manager 636 may activate alarms (audible and visible) around the tire cage a50 s well as provide output to the display(s) 421 and speakers associated with the computer 424.

The controller 620 further includes a tire cage lid and locking pin controller 644 which performs programmatic elements (software) indicative of the following high level pseudo-code:

TireCageLid&LockingPinCntrl(Request, Status) {

// “Request” inputs the type of request to be performed; ″Status″ is for outputting a status
CaseOf (Request):

Close_lid: /* Request to close the lid 60 */ {

Close_Lid(Status); /* Attempt to close the lid 60; “Status” returns: “CloseSuccess”, or

“CloseFailure” depending, respectively, on whether the lid 60 closed
successfully or failed to close. See description of this program below. */

If (Status == “CloseFailure”) Then { // lid 60 did not close

Activate emergency stop manager 636 to, e.g., put the lid 60 in a predetermined

configuration, activate alarms, and output emergency message to the display(s)
421;

Exit; // Terminate the TireCageLid&LockingPinCntrl program

}} /* EndClose_Lid */

Close&Lock_lid: /* Request to close & lock the lid 60 */ {

Close_Lid(Status); /* See description of this program below. */
If (Status == “CloseFailure”) Then { // lid 60 did not close

Activate emergency stop manager 636 to, e.g., put the lid 60 in a predetermined

configuration,, activate alarms, and output emergency message to the display(s)
421;

Exit; // Terminate the TireCageLid&LockingPinCntrl program

}
If (a sensor 640 indicates the lid 60 is not locked closed) Then

Status ← Activate the actuators 230 for locking the lid 60 closed;
/* “Status” returns with either “LidLockedClosedSuccess” or

“LidLockedClosedFailure” */

Else /* the lid 60 is locked closed */

Status ← “LidLockedClosedSuccess”;

Notify operator of the status of the lid 60, i.e., the lid 60 is closed, but may or may not be

locked;

} /* End Close&Lock_lid */

Open_lid: /* Request to open the lid 60 */ {

Open_Lid(Status); /* Attempt to open the lid 60; “Status” returns: “OpenSuccess”, or

“OpenFailure” depending, respectively, on whether the lid 60 opened successfully or
failed to open. See description of this program below. */

If (Status == “OpenFailure”) Then { // the lid 60 did not open

Activate emergency stop manager 636 to, e.g., put the lid 60 in a predetermined

configuration, activate alarms, and output emergency message to the display(s)
421;

Exit; // Terminate the TireCageLid&LockingPinCntrl program

}} /* EndOpen_Lid */

Open&Lock_lid: /* Request to open & lock the lid 60 */ {

Open_Lid(Status); /* See description of this program below. */
If (Status == “OpenFailure”) Then { // the lid 60 failed to entirely open

Activate emergency stop manager 636 to, e.g., put the lid 60 in a predetermined

configuration, activate alarms, and output emergency message to the display(s)
421;

Exit; // Terminate the TireCageLid&LockingPinCntrl program

}} /* End Open&Lock_lid */
If (a sensor 640 indicates the lid 60 is not locked open) Then

Status ← Activate the actuators 182 for locking the lid 60 open;
/* “Status” either “LidLockedOpenSuccess” or “LidLockedOpenFailure” */

Else /* the lid 60 is locked open */

Status ← “LidLockedOpenSuccess”;

Notify operator of the status of the lid 60, i.e., the lid 60 is open, but may or may not be

locked open;

} /* End TireCageLid&LockingPinCntrl */

Psuedo-code for the program “Close Lid” follows.

Close_Lid(Status) {

If (a sensor 640 indicates the lid 60 is not closed) Then

While (a sensor 644 does not indicate an obstruction to closing the lid 60) DO

If (the lid 60 is locked open) Then {

Unlock safety pins 178 via activation of the actuators 182;
If (the safety pins 178 are unlocked, e.g., as may be detected by one or more

sensors 640) Then

Status ← Activate cylinder 190 for lowering the lid 60;

/* “Status” indicates result from activating the cylinder 190 for lowering

the lid 60; “Status” may have values of: “CloseSuccess”, or
“CloseFailure” */

Else { /* safety pins 178 are not unlocked */

Notify operator of a malfunction;
Terminate any processes for inspecting a tire 58;
Prepare a corresponding malfunction record to be logged;
Terminate “While” loop; Status ← “CloseFailure”;

}

Else /* the lid 60 is not closed, but not locked open */

Status ← Activate the cylinder 190 for lowering the lid 60;
/* “Status” indicates result from activating the cylinder 190 for lowering the lid

60; “Status” may have values of: “CloseSuccess”, or “CloseFailure” */

Else /* the lid 60 is closed */

Notify operator that the lid 60 is closed; Status ← “CloseSuccess”;

} // End “Close_Lid”

Psuedo-code for the program “Open_Lid” follows.

Open_Lid(Status) {

If (a sensor 640 indicates the lid 60 is not open) Then

While (a sensor 644 does not indicate an obstruction to opening the lid 60) DO

If (the lid 60 is locked closed) Then

Unlock pins 232 via activation of the actuators 230;
If (the pins 232 are unlocked, e.g., as may be detected by one or more sensors

640) Then

Status ← Activate cylinder 190 for opening the lid 60;
/* “Status” indicates result from activating the cylinder 190 for opening

the lid 60; “Status” may have values of: “OpenSuccess”, or
“OpenFailure” */

Else { /* pins 232 are not unlocked */

Notify operator of a malfunction;
Terminate any processes for inspecting a tire 58;
Prepare a corresponding malfunction record to be logged;
Terminate “While” loop; Status ← “OpenFailure”;

}

Else /* the lid 60 is not open, but not locked closed */

Status ← Activate the cylinder 190 for opening the lid 60;
/* “Status” indicates result from activating the cylinder 190 for opening the lid

60; “Status” may have values of: “OpenSuccess”, or “OpenFailure” */

Else /* the lid 60 is open */

Notify operator that the lid 60 is open; Status ← “OpenSuccess”;

} // End “Open_Lid”

The controller 620 further includes a front plate controller 648 which performs programmatic elements (software) indicative of high level pseudocode substantially similar to the pseudocode above for the tire cage lid & locking pin controller 644. In particular, by replacing all occurrences of “Lid” with “FrontPlate”, replacing “lid 60” with “front plate 202”, replacing all occurrences of “cylinder 190” with “actuator 204” in the pseudo-code CloseLid and OpenLid program elements above, corresponding program elements CloseFrontPlate and OpenFrontPlate may be obtained. Accordingly, the following pseudo-code is obtained as a high level embodiment of the controller 648.

Psuedo-code for the program “FrontPlateController” follows.

FrontPlateController(Request, Status) {

// “Request” inputs the type of request to be performed; ″Status″ is for outputting a status
Case (Request) of:

Close_frontplate: { /* Request to close the front plate 202 */

Close_FrontPlate(Status);
If (Status == “CloseFailure”) Then {

Activate emergency stop manager 636 to, e.g., put the lid 60 in a predetermined

configuration, activate alarms, and output emergency message to the display(s)
421;

Exit; // Terminate the FrontPlateController program

}} /* End Close_FrontPlate */

Open_frontplate: { /* Request to open the lid 60 */

Open_FrontPlate (Status);
If (Status == “OpenFailure”) Then {

Activate emergency stop manager 636, e.g., put the lid 60 in a predetermined

configuration, activate alarms, and output emergency message to the display(s)
421;

Exit; // Terminate the FrontPlateController program

}} /* End Open_frontplate */

} /* End FrontPlateController */

The controller 620 also includes a tire scanning & imaging module 652 for obtaining images of a tire 58, wherein upon initialization for subsequently imaging the tire, the tire scanning & imaging module orients the imaging devices 442 and 492 via their respective positioning subassemblies 444 and 496 for the size of the tire, and the height of the tire on the table 159. Additionally, if the lights 468 and 516 for the imaging devices 442 and 492 are also positionable, then such lights may also be positioned according to the size of the tire 58 and the height of the tire on the table 159. Once such initialization is completed, the tire scanning & imaging module 652 may image/scan the tire 58 via operator input through the operator interface 621 (e.g., which may include a graphical user interface for presentation on the display(s) 421), wherein the operator may request the image/scan to be performed by an automated scan that occurs without further operator input, or the operator may interrupt such an automated scan to obtain further images (pictures and/or videos) of particular portions of the tire 58, e.g., for a more close inspection, and/or for capturing such further images in the tire image database 624 for monitoring and comparing the tire portions imaged with the same tire portions in future inspections of the tire. In one embodiment, the tire imaging module 652 performs the following high level pseudo-code for each side of the tire 58, and again for the tire's tread:

/* The following programmatic element receives as input, in the parameter “TirePortionToBeScanned”,

data indicating which portion of the tire 58 to scan, and returns a value of “Success” or “Failure” in
the parameter “ReturnStatus”, such values having their conventional meaning, */

TireImagingCntrl(TirePortionToBeScanned, ReturnStatus) {

Confirmed ← Confirm that the tire cage 50 operator wishes to commence imaging the tire 58 in

the tire cage 50; /* The operator confirms by an input to the computer 424 via operator
interface 621. */

If (NOT Confirmed) Then {

// Operator has not confirmed to scan; so the operator has cancelled the tire scan.
ReturnStatus ← ″Failure″;
Return; // Terminate tire imaging
}

// Operator has confirmed that imaging is to occur
Tire_identification ← get the tire 58 identification, e.g., from operator input to the interface 621;

/* E.g., the tire 58 identification and/or the rim identification number. */

If (the tire 58 does not have Tire_identification in the tire attribute database 622) Then {

Tire_attributes ← get tire attributes from the operator; /* Such tire attributes being, e.g.,

the data described in (622.a) and (622.b) above */

Create a tire record for the tire 58 in the attribute database 622;

}

Else { // The tire attribute database 622 already has data on the tire 58

Tire_attributes ← get tire attributes from the tire attribute database 622 using the

″Tire_identification″; /* Such attributes may include the tire size, tire make & model, tire
identifier(s) (for the tire casing and/or the tire rim) for uniquely identifying the tire 58, and
in one embodiment, the data of (622.a) through (622.f) hereinabove. */

}

If (TirePortionToBeScanned == ″TopTireSide″) Then

Top_imaging_device_position ← get default (initial) top imaging device 442 data from the

Tire_attributes; /* If top lights 468 (Fig. 18) are positionable, then retrieve default
(initial) position here as well. Get values (if any) for the following parameters that apply
to the current portion (e.g., top tire side) of the tire 58 to be imaged from the tire attribute
database 622 (i.e., for the top tire side, (a)-(f) immediately following are applicable):

| | |
|---|---|
| (a) | Scan_type, // Initial type of imaging: automatic or manual control of imaging |
| (b) | Tire_rotation_rate, |
| (c) | Tire_rotation_direction, /* E.g., “clockwise” or “counterclockwise” This is |

the direction of table 159 rotation for rotating the tire 58; note that
″Tire_rotation_rate″ may be zero which means the tire 58 is not rotating
on the table 159. */

| | | |
|---|---|---|
| (d) | Table_height | // E.g., the height of the table 159 for imaging the tire |

| | | |
|---|---|---|
| (e) | Top_imaging_device_position, | /* Translation and/or angular orientation |

| | values for the imaging device 438 */ | |
|---|---|---|
| (f) | Top_imaging_device_zoom, | /* zoom value for imaging device 438, |

| | e.g., in percentage of magnification */ | |
|---|---|---|
| (g) | Bottom_imaging_device_position, | /* Translation and/or angular |

| | orientation values for the imaging device 492 */ | |
|---|---|---|
| (h) | Bottom_imaging_device_zoom, | /* zoom value for imaging device 492, |

| | e.g., in percentage of magnification */ | |
|---|---|---|
| (i) | Tread_imaging_device_position, /* Translation and/or angular orientation | |
| | values for the imaging device 547 */ | |
| (j) | Tread_imaging_device_zoom, | /* zoom value for imaging device 547, |

e.g., in percentage of magnification */

ElseIf (TirePortionToBeScanned == ″BottomTireSide″) Then

Bottom_imaging_device_position ← get default (initial) bottom imaging device 492 data

from the Tire_attributes; /* If the bottom lights 516 are positionable, then retrieve default
(initial) position here as well. Values for (a) through (d), (g) and (h) immediately above
are obtained from the tire attribute database 622 for scanning the bottom side of the tire
58. */

ElseIf (TirePortionToBeScanned == ″TireTread″) Then

Tread_imaging_device_position ← get default (initial) tread imaging device 547 data from

the Tire_attributes; /* If the corresponding lights 548 are positionable, then retrieve default
(initial) position here as well. Corresponding values for (a) through (d), (i) and (j) above
are obtained from the tire attribute database 622 for scanning the tread of the tire 58. */

/* In one embodiment, prior to commencing the tire scan, the tire 58 is rotated until the tire's

valve stem is in approximately the center of the field of view of the imaging device 442.
Accordingly, in this embodiment, the imaging device 442 is activated together with the motor
167 to rotate the tire 58 until, e.g., the valve stem (or another predetermined tire location) is
approximately in the center of the field of view of the imaging device 442. Note that other tire
features may be used for determining how to initially orient the tire 58 prior to commencing a
tire scan; e.g., a tag or marking on the tire's rim (e.g., on either side of the rim). In the event
that such a tag or marking is on the bottom side of the tire 58 (in its position in the tire cage
50), the imaging device 492 and light(s) associated therewith may by activated instead of
imaging device 442 and its light(s). For simplicity, it is assumed in the programmatic
statements following that the tire's “scan marker”, e.g., one of a marking, a tag or the tire's
valve stem, is on the top side of the tire 58 according to it orientation in the tire cage 50.
Further note that since each scan of the tire 58 commences preferably from substantially a
same predetermined tire orientation on the table 159, scans of the tire 58 that occur in different
mountings of the tire within the tire cage 50 may be readily compared. Indeed, an operator
may compare, e.g., a most recent tire scan of the tire's top side with a scan of the tire's top
side that took place months or years ago. */

/* It is assumed in the remainder the present program, “TireImagingCntrl”, that the

predetermined marking, tag or valve stem is on the top side of the tire */

Activate the imaging device 442 and its corresponding light(s) 468 for illuminating the top side

of the tire 58 for detecting the predetermined marking, tag or valve stem;

Rotate the tire 58 by activation of the motor 167 until the image from the imaging device 442

shows the tire's scan marker in substantially the center of the imaging device's field of view;
/* In one embodiment, such rotation of the tire 58 for positioning it so that its scan marker is

properly viewed may be performed by the tire operator manually activating the motor
167 until the operator views an image of the tire 58 with its scan marker appropriately
positioned. */

/* Now image the tire 58, including an entire circular scan of the tire as described following. */
Activate the corresponding lights 468, 516, and 548 for illuminating the portion of the tire 58 to

be scanned; /* light(s) 468 for the tire top side, 516 for the tire bottom side, and 548 for the
tire tread */

Focus the designated one of the imaging devices 438, 492 and 547 on the portion of the tire 58

to be scanned; /* 468 for the tire's top side, 516 for the tire's bottom side, and 548 for the
tire's tread */

/* Such focusing may be performed substantially automatically and in real time during

scanning. */

Present an initial image of the portion of the tire 58 to be scanned on the display(s) 421;
If (TirePortionToBeScanned == ″TopTireSide″) Then

Status ← Image_tire_topside(Scan_type, Tire_rotation_rate, Tire_rotation_direction,

Imaging_table_height, Top_imaging_device_position,
Top_imaging_device_zoom);

ElseIf (TirePortionToBeScanned == ″BottomTireSide″) Then

Status ← Image_tire_bottomside(Scan_type, Tire_rotation_rate, Tire_rotation_direction,

```
  Imaging_table_height, Bottom_imaging_device_position,
  Bottom_imaging_device_zoom);
```

ElseIf (TirePortionToBeScanned == ″TireTread″) Then

Status ← Image_tire_tread(Scan_type, Tire_rotation_rate, Tire_rotation_direction,

Imaging_table_height, Tread_imaging_device_position,
Tread_imaging_device_zoom);

} // End TireImagingCntrl, return value of the parameter ″Status″

Since each of the program elements, “Image_tire_topside”, “Image_tire_bottomside”, and “Image_tire_tread” involved above are similar, only the pseudo-code for “Image_tire_topside” is presented hereinbelow.

Image_tire_topside(Scan _type, Tire_rotation_rate, Tire_rotation_direction, Table_height,

Top_imaging_device_position, Top_imaging_device_zoom)

{

Need_Full_Auto_Scan ← TRUE; /* A full automated scan is to be stored in the tire image database

624. */

### LOOP UNTIL A RETURN STATEMENT IS PERFORMED:

{

/* The following program “Perform_tire_topside_imaging” performs only a single type of

imaging at a time given the parameter values provided to it. The types of imaging performed
by “Perform_tire_topside_imaging” are described further below in the present loop, */

Status ← Perform_tire_topside_imaging(Scan_type, Tire_rotation_rate,

Tire_rotation_direction, Table_height, Top_imaging_device_position,
Top_imaging_device_zoom);

If (Status == “EmergencyStop” OR “ImagingFailure”) Then

```
  /* tire imaging & rotation have ceased */
  Return(Status); // Terminate this program and return the value of “Status”
```

ElseIf (Status == “FullAutoImageObtained”) Then

/* An entire automated rotational image of the tire 58 has been obtained */
Need_Full_Auto_Scan ← FALSE;

ElseIf (Status == “ChangeImagingOperation”) Then {

// The operator has requested an imaging change.
// Get list of new operator input scanning instructions via the operator interface 621
ListOfInstructionChanges← get changed imaging control instruction(s) from the tire cage

operator;

Instruction ← Get first instruction in “ListOfInstructionChanges”;
Repeat// perform the following statements until the next “Until” statement is TRUE

// Determine “Instruction” type and set parameter(s) accordingly.
CaseOf (Instruction.Type): {

SwitchToManualScanning: { /* Operator manually controls table 159 height,

and/or rotation as well as the zoom, orientation and position of the imaging
device 442. The operator may provide such an instruction before or after the
automated scan of the tire 58 completes. */
Scan_type ← “ManualScan”;
TireRotationRateChange ← 0; // Stop tire rotation (if not already stopped)
Enable operator manual control to orient and position the imaging device 442;
Enable operator manual control to rotate the table 159 (and tire 58 thereon),

```
  wherein the operator can in small increments vary the tire rotation
  direction and rate;
```

Enable operator manual control of the table 159 height;
}

SwitchToAutomatedImaging: {

/* The operator previously switched from automated scanning to manual

operation, and now wishes to switch back to automated scanning. In this
case, automated scanning may require re-orientation of the tire 58 (e.g.,
table height and/or tire rotation) to put the tire in a position to continue the
previous automatic scan. Alternatively, (and likely preferably) the
automatic scan may reinitialize and start over for a full scan of the tire 58. */

Scan_type ← “AutomatedScan”;
Reinitialize tire scanning parameters (a)-(f) above from the tire attribute

database 622;

}

TireRotationRateChange: // Change the rotation rate of the table 159

// New tire rotation rate may be zero for stopping tire rotation
Tire_rotation rate ← Instruction.rotation_rate;

ReverseTableRotation: { // Change rotation direction, but start out slow

Tire_rotation_rate ← Get a “slow” rotation rate;
Tire_rotation_direction ← Get opposite tire rotation direction from the current

tire rotation direction;

}

ZoomImaging: { // Set new zoom value for the imaging device being used

Scan_type ← “ManualScan”;
Top_imaging_device_zoom ← Instruction.zoom; // Assign new zoom value
}

ChangeTopImagingDeviceOrientation: {

Scan_type ← “ManualScan”;
Enable operator manual control to orient and position the imaging device 442;
Enable operator manual control to rotate the table 159 (and tire 58 thereon),

```
  wherein the operator can in small increments vary the tire rotation
  direction and rate;
```

}

TakeTirePhoto: {

Scan_type ← “ManualScan”;
TireRotationRateChange ← 0; // Stop tire rotation (if not already stopped)
Enable operator manual control to orient and position the imaging device 438;
Enable operator manual control to rotate the table 159 (and tire 58 thereon),

```
  wherein the operator can in small increments vary the tire rotation
  direction and rate;
```

Enable operator manual control of table 159 height;
Enable the capturing of a tire image photo shown to the operator on the

```
  display(s) 421 so that the operator can store the photo in the tire image
  database 624;
```

RedoAutomatedScan: {

/* In this case, the operator may not have liked the automated scan due to, e.g.,

dirt on the tire 58, dirt or oil on the image recording assembly 426
preventing a good quality tire scan. Note, redoing an automated tire scan
may require re-orientation of the tire 58 (e.g., table height and/or tire
rotation) to put the tire in a position to continue the previous automatic scan.
Alternatively, (and likely preferably) the automatic scan may reinitialize
and start over from the predetermined scan identifier on the tire and perform
a full rotational scan of the tire 58. Accordingly, the image data for such a
redo scan will overwrite any immediately previous tire scan data entered
into the tire image database 624. */

Scan_type ← “RedoAutomatedScan”;
Reinitialize tire scanning parameters (a)-(f) above from the tire attribute

database 622;

}

} // End Case Statement
Instruction ← Next (if any) instruction on “ListOfInstructionChange”;

Until (“Instruction” does not identify an operator instruction);

} // End ElseIf // for “ChangeImagingOperation”
ElseIf (Status == “DONE”) Then {

/* check to see if a full rotational automated tire was performed */

If (Need_Full_Auto_Scan) Then { // note this in the database 622

Insert data in the tire attribute database 622 indicating that a full 360 degree scan of the tire's
topside was not performed;
Return(“AutoScanIncomplete”);

} END LOOP

} // End Image_tire_topside

The controller 620 also includes a tire inflation & deflation manager 656, wherein the inflating and deflating the tire may be restricted to maximum rates and/or protocols that are deemed more safe, wherein tire inflation and deflation rates, pressures and/or durations may be substantially computer controlled instead of operator controlled. In one embodiment, a tire 58 may be inflated and/or deflated in a stepped protocol within the tire cage 50, wherein the tire is inflated/deflated to a first pressure, held at the first pressure for a predetermined time and/or until the tire is reimaged by the tire imaging equipment (preferably, imaging at least an entire circular juncture between the tire's split rim and the remainder of the tire 58). In another embodiment, such a tire inflation/deflation protocol may include repeated steps of alternately inflating followed by at least a partial deflation, or a deflation followed by a partial re-inflation. Other such inflation/deflation protocols are also within the scope of the present disclosure.

The controller 620 may further include tire replacement and life predictor module 660 for: (a) identifying tires 58 whose tire casings need to be replaced, or assisting personnel in making such a determination, and/or (b) predicting when tires 58 may likely need to be replaced. Such a module 660 may be statistically based wherein such replacement and/or prediction for a tire 58 is determined, e.g., according to the tread remaining on the tire, the number and severity of anomalous tire conditions detected, and the length of time the tire has been in service.

At least the features described hereinabove related to the energy absorbing assemblies 254, the subassemblies 262, the various sensors (including the sensors 560) and/or the imaging devices 438 and 492 (and their corresponding positioning assemblies 442 and 492) as well as the computational features of the controller 620 may be applicable to various types of equipment and/or safety related issues. For example, both equipment and personnel need to be protected from explosive and/or high energy impacting projectiles or debris in mining, drilling, explosion related equipment (e.g., large guns on ships), accidents involving a moving object, vehicle or equipment (e.g., automobile or train accidents). In particular, in mining transportable blast containment structures may be desirable for providing blast protection. Moreover, such transportable blast containment structure may have one or more layers of assemblies 254 (FIG. 21) or similar assemblies. Such layers may be substantially reduced in weight and/or size (particularly, in thickness corresponding to the direction of the axis 568 in FIG. 21). Accordingly, such assemblies 254 may be manufactured as a single unit for use in various applications, wherein the plates 260 and 564 may be substantially reduced/increased in size and/or weight in comparison to such assemblies for embodiments of the tire cage 50, and the subassemblies 262 may be sized, and of a composition, appropriate to absorb explosions whether such explosions release energy/forces that are above or substantially below the estimated 3500 to 3700 kiloNewtons (kN) and 1160 kiloJoules (kJ) of energy for embodiments of the tire cage 50. Moreover, the subassemblies 262 may be fixedly sandwiched between embodiments of the plates 260 and 564 so that, e.g., resulting assemblies 262 may be provided in various orientations or angular inclinations. In addition to being readily transportable blast containment structures (e.g., that are substantially lighter and less bulky than prior art such containment structures for withstanding a given explosive energy/force), such assemblies 254 may include sensors 560, and computational features of the controller 620 may be also provided with such assemblies 254 for determining when an assembly 254 must be replaced, can be reused, and/or an estimated energy/force that it can still absorb (in another blast). Accordingly, such assemblies 254 may be manufactured for protecting personnel or equipment from falling rocks, methane or other explosions wherein substantial debris may be projected at high energy. In one embodiment, such assemblies 254 may be used for elevator malfunctions for safely absorbing energy/force from a substantially free falling elevator.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

### APPENDIX

In order to test various combinations of metallic foams for absorbing energy from a tire explosion, tests of various arrangements of various types of metallic foams was conducted. It was assumed that the total impact force of an energy absorption structure 252 (FIGS. 1 and 8) should be approximately 3,546 kiloNewtons or equivalently 797,136 foot-pounds. With 16 subassemblies 262 (FIG. 6) per energy for the energy absorbing structure 252 (each having a single unitary foam block 264), this equates to 49,821 lb-feet of energy absorption per subassembly 262. Moreover, the tests were configured using various arrangements of a plurality of subassemblies 262, wherein for most of the arrangements the subassemblies had blocks 264 of differing characteristics (e.g., such characteristics as block length, block width, block foam density, and crush plateau, i.e., the maximum crushing force that can be absorbed before substantially all subsequently applied forces are entirely transferred through the block). Accordingly, an arrangement could include: (i) one or more “primary blocks” having particular block characteristics, (ii) one or more “second blocks” having different block characteristics, and in some tests (iii) one or more “tertiary blocks” having yet another different set of block characteristics.

In performing the tests, the following additional constraints were imposed on the arrangements:
(a) Neither the length nor the width of any individual subassembly 262 was be less than four inches in order to maintain at least a 1:2 ratio with the eight inch height (i.e., thickness) of each block 264. Note that it is believed that by maintaining such a ratio, a global buckling of the blocks during compression can be prevented.
(b) The primary blocks were located at substantially the four corners of the decoupling plate 260.
(c) Any adjustments in the arrangement were accomplished by rearranging the blocks not located at substantially the four corners of the decoupling plate 260.
(d) All metallic foams were aluminum foams.

Thirty-two different arrangements were tested, all arrangements providing substantially identical energy absorbing performance and having substantially identical overall dimensions. The following three tables describe the thirty-two arrangements tested, wherein the first table describes the how the primary blocks were arranged for each of the thirty-two arrangements, the second table describes the how the (any) secondary blocks were arranged for each of the thirty-two arrangements, and the third table describes the how the (any) tertiary blocks were arranged for each of the thirty-two arrangements.

TABLE 1

| | Primary | | Block | Block | Number of | Position of | Crush Plateau | |
|---|---|---|---|---|---|---|---|---|
| Subassembly | Foam Density | Heat Lot | Length (in.) | Width (in.) | Blocks | Blocks | (PSI) | Subassembly |
| 1* | 9.6 | 10223-1 | 5.505 | 6.000 | 4 | All Corners | 377.07 | 1* |
| 2 | 8.1 | 10223-1/5320-1 | 5.796 | 6.000 | 2 | Opposite Corners | 289.86 | 2 |
| 3 | 7.8 | 10223-1/5320-1 | 4.752 | 7.000 | 4 | All Corners | 272.42 | 3 |
| 4 | 7.7 | 10223-1/5320-1 | 6.000 | 6.000 | 2 | Opposite Corners | 266.61 | 4 |
| 5 | 10.0 | 10223-1 | 5.000 | 7.000 | 2 | Opposite Corners | 400.33 | 5 |
| 6 | 10.0 | 10223-1 | 5.000 | 7.000 | 2 | Opposite Corners | 400.33 | 6 |
| 7 | 10.0 | 10223-1 | 5.000 | 7.000 | 2 | Opposite Corners | 400.33 | 7 |
| 8* | 9.7 | 8186-1 | 5.351 | 6.000 | 2 | Opposite Corners | 382.89 | 8* |
| 9 | 9.8 | 8186-1 | 6.000 | 6.000 | 2 | Opposite Corners | 388.70 | 9 |
| 10 | 9.7 | 8186-1 | 6.000 | 6.000 | 2 | Opposite Corners | 382.89 | 10 |
| 11 | 8.3 | 10223-1/5320-1 | 6.000 | 6.000 | 2 | Opposite Corners | 301.49 | 11 |
| 12 | 9.9 | 8186-1 | 5.000 | 7.000 | 2 | Opposite Corners | 394.52 | 12 |
| 13 | 8.5 | 10223-1 | 5.000 | 7.000 | 2 | Opposite Corners | 313.12 | 13 |
| 14 | 8.2 | 10223-1/5320-1 | 6.000 | 6.000 | 4 | All Corners | 295.68 | 14 |
| 15 | 8.1 | 10223-1/5320-1 | 5.000 | 7.000 | 4 | All Corners | 289.86 | 15 |
| 16 | 9.6 | 10223-1/5320-1 | 6.000 | 6.000 | 2 | Opposite Corners | 377.07 | 16 |
| 17 | 8.3 | 10223-1 | 6.000 | 6.000 | 2 | Opposite Corners | 301.49 | 17 |
| 18 | 9.7 | 10223-1/5320-1 | 4.000 | 6.942 | 4 | All Corners | 382.89 | 18 |
| 19 | 9.1 | 10223-1/5320-1 | 4.000 | 6.848 | 4 | All Corners | 348.00 | 19 |
| 20 | 8.2 | 10223-1/5320-1 | 4.000 | 6.910 | 4 | All Comers | 295.68 | 20 |
| 21 | 8.3 | 8186-1 | 4.000 | 6.776 | 4 | All Corners | 301.49 | 21 |
| 22* | 8.6 | 10223-1/5320-1 | 4.000 | 6.904 | 4 | All Corners | 318.93 | 22* |
| 28 | 7.8 | 10223-1/5320-1 | 5.000 | 7.000 | 4 | All Corners | 272.42 | 23 |
| 24 | 8 | 10223-1/5320-1 | 4.000 | 6 739 | 4 | All Corners | 284.05 | 24 |
| 25 | 8 | 10223-1/5320-1 | 4.000 | 6.856 | 4 | All Corners | 284.05 | 25 |
| 26 | 8 | 10223-1/5320-1 | 4.000 | 6.856 | 4 | All Corners | 284.05 | 26 |
| 27 | 8 | 10223-1/5320-1 | 4.000 | 6.769 | 4 | All Corners | 284.05 | 27 |
| 28 | 8 | 10223-1/5320-1 | 6.000 | 6.000 | 4 | All Corners | 284.05 | 28 |
| 29 | 8.1 | 10223-1/5320-1 | 5.000 | 6.866 | 4 | All Corners | 289.86 | 29 |
| 30 | 8.1 | 10223-1/5320-1 | 5.000 | 6.866 | 4 | All Corners | 289.86 | 30 |
| 31 | 8.2 | 10223-1 | 6.000 | 6.000 | 4 | All Corners | 295.68 | 31 |
| 32 | 8.3 | 10223-1/5320-1 | 5.000 | 6.775 | 4 | All Corners | 301.49 | 32 |

TABLE 2

| | Secondary | | Block | Block | Number of | Position of | Crush Plateau |
|---|---|---|---|---|---|---|---|
| Subassembly | Foam Density | Heat Lot | Length (in.) | Width (in.) | Blocks | Blocks | (PSI) |
| 1* | | | | | | | |
| 2 | 10.2 | 8186-1 | 6.000 | 6.000 | 2 | Opposite Corners | 411.96 |
| 3 | 0.6 | 10223-1/5320-1 | 6.000 | 6.000 | 1 | Center | 377.07 |
| 4 | 7.6 | 10223-1 | 6.000 | 6.000 | 2 | Opposite Comers | 260.79 |
| 5 | 8.7 | 10223-1 | 4.794 | 7.000 | 2 | Opposite Corners | 324.75 |
| 6 | 8.5 | 10223-1/5320-1 | 5.801 | 6.000 | 2 | Opposite Corners | 313.12 |
| 7 | 8.4 | 10223-1/5320-1 | 5.911 | 6.000 | 2 | Opposite Corners | 307.31 |
| 8* | 6.3 | 10223-1 | 6.000 | 6.000 | 2 | Opposite Corners | 185.21 |
| 9 | 8.4 | 10223-1/5320-1 | 5.921 | 6.000 | 2 | Opposite Corners | 307.31 |
| 10 | 10.6 | 10223-1/5320-1 | 4.000 | 6.391 | 2 | Opposite Corners | 435.21 |
| 11 | 8.0 | 10223-1/5320-1 | 6.000 | 6.000 | 2 | Opposite Corners | 284.05 |
| 12 | 6.6 | 10223-1 | 6.000 | 6.000 | 2 | Opposite Corners | 202.65 |
| 13 | 8.4 | 10223-1/5320-1 | 6.000 | 6.000 | 2 | Opposite Corners | 307.31 |
| 14 | 7.1 | 10223-1/5320-1 | 4.466 | 7.000 | 1 | Center | 231.72 |
| 15 | 8.4 | 10223-1 | 4.295 | 7.000 | 1 | Center | 307.31 |
| 16 | 6.8 | 8186-1 | 6.000 | 6.000 | 2 | Opposite Corners | 214.28 |
| 17 | 10.5 | 10223-1/5320-1 | 4.000 | 6.121 | 2 | Opposite Corners | 429.40 |
| 18 | 6.6 | 10223-1 | 6.000 | 6.000 | 1 | Center | 202.65 |
| 19 | 8.7 | 10223-1/5320-1 | 6.000 | 6.000 | 1 | Center | 324.75 |
| 20 | 11.3 | 8186-1 | 6.000 | 6.000 | 1 | Center | 475.91 |
| 21 | 11.3 | 8186-1 | 6.000 | 6.000 | 1 | Center | 475.91 |
| 22* | 6.6 | 10223-1 | 6.000 | 6.000 | 2 | Top/Bottom Center | 202.65 |
| 23 | 8.7 | 10223-1/5320-1 | 5.995 | 6.000 | 1 | Center | 324.75 |
| 24 | 7.7 | 10223-1/5320-1 | 6.000 | 6.000 | 2 | Top/Bottom Center | 266.61 |
| 25 | 7.8 | 10223-1/5320-1 | 5.000 | 6.850 | 2 | Top/Bottom Center | 272.42 |
| 26 | 7.7 | 10223-1/5320-1 | 5.000 | 7.000 | 2 | Top/Bottom Center | 266.61 |
| 27 | 7.9 | 10223-1 | 5.000 | 6.850 | 2 | Top/Bottom Center | 278.24 |
| 28 | 7.4 | 10223-1 | 5.965 | 6.000 | 1 | Center | 249.17 |
| 29 | 7.9 | 10223-1 | 6.000 | 6.000 | 1 | Center | 278.24 |
| 30 | 7.9 | 10223-1 | 6.000 | 6.000 | 1 | Center | 278.24 |
| 31 | 6.6 | 10223-1 | 6.000 | 5.957 | 1 | Center | 202.65 |
| 32 | 7.4 | 10223-1 | 6.000 | 6.000 | 1 | Center | 249.17 |

TABLE 3

| | Tertiary | | Block | Block | Number of | Position of | Crush Plateau | Crush Force |
|---|---|---|---|---|---|---|---|---|
| Subassembly | Density | Heat Lot | Length | Width | Blocks | Blocks | (PSI) | (lbf) |
| 1* | | | | | | | | 49821 |
| 2 | | | | | | | | 49821 |
| 3 | | | | | | | | 49821 |
| 4 | 9.6 | 10223-1/5320-1 | 5.237 | 6.000 | 1 | Center | 377.07 | 49821 |
| 5 | | | | | | | | 49821 |
| 6 | | | | | | | | 49821 |
| 7 | | | | | | | | 49821 |
| 8* | 8.8 | 10223-1 | 6.000 | 6.000 | 1 | Center | 330.56 | 49821 |
| 9 | | | | | | | | 49821 |
| 10 | | | | | | | | 49821 |
| 11 | 7.0 | 10223-1/5320-1 | 5.000 | 6.783 | 1 | Center | 225.91 | 49821 |
| 12 | 7.0 | 10223-1/5320-1 | 5.000 | 6.741 | 1 | Center | 225.91 | 49821 |
| 13 | 6.4 | 10223-1/5320-1 | 5.040 | 6.000 | 1 | Center | 191.03 | 49821 |
| 14 | | | | | | | | 49821 |
| 15 | | | | | | | | 49821 |
| 16 | 7.1 | 10223-1/5320-1 | 4.466 | 7.000 | 1 | Center | 231.72 | 49821 |
| | | | | | | | Total (lbf): | 797136 (3546 kN) |
| 17 | 6.5 | 8186-1 | 6.000 | 6.000 | 1 | Center | 196.84 | 49821 |
| 18 | | | | | | | | 49821 |
| 19 | | | | | | | | 49821 |
| 20 | | | | | | | | 49821 |
| 21 | | | | | | | | 49821 |
| 22* | | | | | | | | 49821 |
| 23 | | | | | | | | 49821 |
| 24 | | | | | | | | 49821 |
| 25 | | | | | | | | 49821 |
| 26 | | | | | | | | 49821 |
| 27 | | | | | | | | 49821 |
| 28 | | | | | | | | 49821 |
| 29 | | | | | | | | 49821 |
| 30 | | | | | | | | 49821 |
| 31 | | | | | | | | 49821 |
| 32 | | | | | | | | 49821 |

What is claimed is:

1. A tire cage, comprising:
a frame having first and second frame members;
a tire support for supporting a tire between at least a portion of the first frame member and at least a portion of the second frame member;
at least one layer of an energy absorbing material, and positioned between the first frame member and the tire support;
wherein when debris from an explosion of the tire is projected toward the first frame member, a deforming of the energy absorbing material is effective for absorbing a sufficient amount of the debris' kinetic energy so that by replacing the energy absorbing material, the first frame member is effective for withstanding an explosion of another tire on the tire support;
a first imaging device mounted to the tire cage, wherein the first imaging device is positioned for imaging a split rim of the tire and a casing of the tire for identifying a potentially unsafe tire condition; and
a controller for determining that an entire circular portion of the tire is imaged using the first imaging device.
